(19) United States
(12) Patent Application Publication
(10) Pub. No.: US 2008/0232015 A1
(43) Pub. Date: Sep. 25, 2008

(54) CIRCUIT ABNORMALITY DETERMINING APPARATUS AND METHOD

(75) Inventors: Katsuhiko WAKABAYASHI, Atsugi-shi (JP); Akihiro Sato, Yokohama-shi (JP); Toshiyuki Innami, Mito-shi (JP); Hitoshi Kobayashi, Tokyo (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/041,019

(22) Filed: Mar. 3, 2008

(30) Foreign Application Priority Data
Mar. 22, 2007 (JP) 2007-073851

(51) Int. Cl. H02H 3/00

(52) U.S. Cl. 361/79

(57) ABSTRACT

In circuit abnormality determining apparatus and method applicable to a brake control apparatus, an abnormality determining section determines at least one of an abnormality location of the electric circuit and an abnormality kind of the electric circuit on a basis of monitoring results of a current state in the electric circuit detected by a current detection section, a voltage state of the electric circuit detected by a open circuit detection section, and a power supply voltage.

### BACKGROUND OF THE INVENTION

1. Field of the Invention

The present invention relates to circuit abnormality determining apparatus and method which determine a location of an abnormality (or a failure) in an electric circuit or a kind of the abnormality in an electrical circuit.

2. Description of the Related Art

A Japanese Patent Application Publication No. Heisei 11-6812 published on Jan. 12, 1999 (which corresponds to a U.S. Pat. No. 6,164,125 issued on Dec. 26, 2000) exemplifies a previously proposed circuit abnormality determining apparatus which specifies a location of a failure (or an abnormality) according to states of current and voltage in an electric circuit at a time at which a power is supplied to a heater in the electric circuit and at a time at which no power is supplied to the heater.

### SUMMARY OF THE INVENTION

However, in the previously proposed circuit abnormality determining apparatus, a kind of failure such as a short to ground (fault) which has a possibility of an overheat due to a flow of an over-current in the electric circuit and another kind of failure such as an open circuit (fault) in which only a failed load becomes uncontrollable cannot be specified (or determined).

It is, hence, an object of the present invention to provide circuit abnormality determining apparatus and method which are capable of specifying a kind of failure required to stop a control of an apparatus urgently due to an overheat of the apparatus, or so forth and another kind of failure enabling a continuation of the control although a performance of the apparatus is reduced.

According to one aspect of the present invention, there is provided a circuit abnormality determining apparatus, comprising: a power supply: a load disposed in an electric circuit connected to the power supply; a first switching element located between the power supply and the load; a second switching element located at a downstream side of the load; current detecting means for detecting a current state in the electric circuit, the current detecting means being disposed between the load and the first switching element; voltage detecting means for detecting a voltage state of the electric circuit, the voltage detecting means being disposed between the load and the second switching element; power supply voltage monitoring means for monitoring a voltage of the power supply; and abnormality determining means for determining at least one of an abnormality location of the electric circuit and a kind of abnormality of the electric circuit on a basis of monitoring results of the current state detected by the current detecting means, of the voltage state detected by the voltage detecting means, and of the power supply voltage monitoring means.

According to another aspect of the present invention, there is provided with a circuit abnormality determining apparatus, comprising: a power supply; a load disposed in an electric circuit connected to the power supply; a power supply relay located between the power supply and the load; a switching element located at a downstream side of the load and configured to drive the load; a power supply voltage monitoring section configured to monitor a voltage of the power supply; a current monitoring section configured to monitor a current state in the electric circuit; a circuit voltage monitoring section configured to monitor a voltage state in the electric circuit; and an abnormality determining section configured to determine an abnormality pattern of the electric circuit on a basis of a monitoring state of each of the power supply voltage monitoring section, the current monitoring section, and the circuit voltage monitoring section.

According to a further aspect of the present invention, there is provided a circuit abnormality determining apparatus, comprising: a power supply; a plurality of loads disposed in an electric circuit connected to the power supply; a power supply relay located between the power supply and the plurality of loads; a switching element located at a downstream side of each of the plurality of loads and configured to drive a corresponding one of the plurality of loads; a power supply voltage monitoring section configured to monitor a voltage of the power supply; a current monitoring section configured to monitor a current state in the electric circuit; a circuit voltage monitoring section configured to monitor a voltage state in the electric circuit; and an abnormality determining section configured to determine an abnormality pattern of the electric circuit on a basis of a monitoring state of each of the power supply voltage monitoring section, the current monitoring section, and the circuit voltage monitoring section.

According to a still further aspect of the present invention, there is provided with a circuit abnormality determining apparatus applicable to a brake control apparatus, comprising: a wheel cylinder attached onto each of road wheels of a vehicle; a control unit configured to control a pressure in the wheel cylinder to reach to a target wheel cylinder pressure; a proportional solenoid valve controlled by the control unit during a control of the pressure in the wheel cylinder; a power supply mounted in the vehicle; a solenoid valve drive circuit connected to the power supply and configured to drive the proportional solenoid valve; a coil disposed in the solenoid valve drive circuit; a power supply relay located between the power supply and the coil; a switching element located at a downstream side of the coil and configured to drive the coil; a power supply voltage monitoring section configured to monitor a voltage of the power supply; a current monitoring section configured to monitor a current in the solenoid drive circuit; a circuit voltage monitoring section configured to monitor a voltage state in the solenoid drive circuit; and an abnormality determining section configured to determine an abnormality pattern of the solenoid valve drive circuit on a basis of a monitoring state of each of the power supply voltage monitoring section, the current monitoring section, and the circuit voltage monitoring section.

According to a still another aspect of the present invention, there is provided with a circuit abnormality determining method, comprising: providing a power supply; providing a load disposed in an electric circuit connected to the power supply; providing a first switching element located between the power supply and the load; providing a second switching element located at a downstream side of the load; and determining at least one of a location of an abnormality in the electric circuit and a kind of the abnormality of the electric circuit on a basis of a current state in the electric circuit which varies in accordance with a drive of at least one of the first switching element and the second switching element, at a position in the electric circuit between the load and the first switching element, a voltage state of the electric circuit which varies in accordance with a drive of at least one of the first switching element and the second switching element, at another position in the electric circuit between the load and the second switching element, and the voltage state of the power supply.

According to the present invention, the failure required to stop a control over a device urgently due to a dangerousness such as an overheat and the failure to enable a continuation of the control although a performance of the device is lowered can be identified so that a countermeasure in accordance with the kinds of failures can be made.

### BRIEF DESCRIPTION OF THE DRAWINGS

FIG. 1 is a configuration view representing a brake liquid pressure circuit of a brake control apparatus in a preferred embodiment to which circuit abnormality determining apparatus and method according to the present invention are applicable.

FIGS. 2A, 2B, and 2C are integrally a block diagram representing a control unit of the brake control apparatus shown in FIG. 1.

FIGS. 3A and 3B are integrally a block diagram representing a control circuit structure of a first liquid pressure control group shown in FIGS. 2A, 2B, and 2C.

FIGS. 4A and 4B are integrally a block diagram representing a control circuit structure of a second liquid pressure control group shown in FIGS. 2A, 2B, and 2C.

FIG. 5A is a schematic circuit diagram representing a control circuit structure of a representative solenoid in the embodiment shown in FIGS. 1, 2A, 2B, 3A, 3B, 4A, and 4B and failure modes (1) through (16) in the control circuit structure thereof.

FIGS. 5B, 5C, and 5D are integrally a table representing detection value results of respective detection sections corresponding to respective failure modes shown in FIG. 5A.

FIG. 6 is a flowchart representing a flow of process of controlling a timing at which a failure detection process for the brake control apparatus in the preferred embodiment shown in FIGS. 1 through 5A is carried out.

FIGS. 7A and 7B are integrally a flowchart representing a flow of the failure detection process when a failsafe relay shown in the embodiment in FIGS. 1 through 5A is in an off state.

FIGS. 8A and 8B are integrally a flowchart representing a flow of the failure detection process when the failsafe relay is in an on state and a driving element shown in FIGS. 1 through 5A is in an off state.

FIGS. 9A and 9B are integrally a flowchart representing a flow of the failure detection process when the failsafe relay is in an on state and the driving element shown in FIGS. 1 through 5A is in the off state.

FIGS. 10A and 10B are integrally a flowchart representing a flow of a brake control process executed by the control unit of brake control apparatus after one failure mode from among the failure modes is specified.

### DETAILED DESCRIPTION OF THE INVENTION

Reference will hereinafter be made to the drawings in order to facilitate a better understanding of the present invention. A best mode of circuit abnormality determining apparatus and method according to the present invention, viz., a preferred embodiment of each of circuit abnormality determining apparatus and circuit abnormality determining method will be described below.

### Embodiment

First, a structure of a brake liquid pressure control apparatus 1 (or simply called, brake control apparatus) to which circuit abnormality determining apparatus and circuit abnormality determining method according to the present invention are applicable will be described below. This brake liquid pressure control apparatus 1 is a, so-called, brake-by-wire system having a brake liquid pressure generating source which is independently separate from a brake liquid pressure generation according to a depression force by a vehicle driver.

(Structure of Brake Liquid Pressure Circuit)

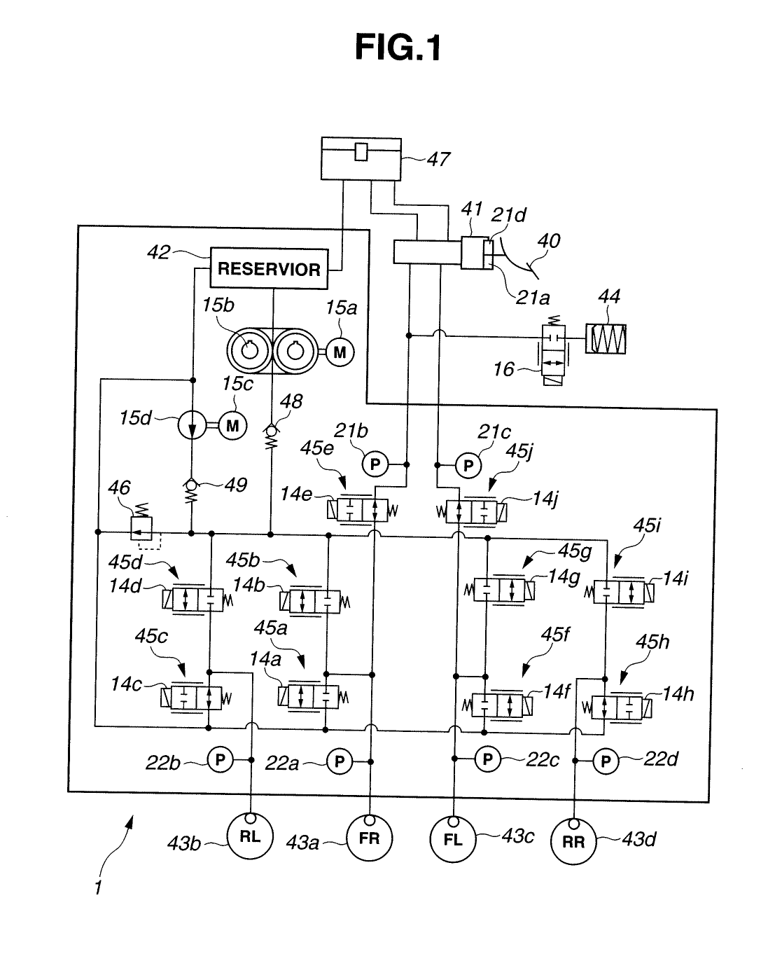

FIG. 1 shows a brake liquid pressure circuit of brake liquid pressure control apparatus 1 in the embodiment. Brake liquid pressure control apparatus 1, as brake liquid pressure sources, includes a master cylinder 41 generating a liquid pressure according to a depression force inputted from a brake pedal 40 by a vehicle driver, a first pump 15b, and a second pump 15d. First pump 15b is driven by a first motor 15a and second pump 15c is driven by a second motor 15c.

Liquid pressure is supplied from a reservoir tank 47 to master cylinder 41. Master cylinder 41 is connected to front right (FR) (road (wheel)) wheel cylinder 43a and to front left (FL) (road (wheel)) wheel cylinder 43c, respectively. Normally open first shutoff (or cutoff) valve 45e is installed between master cylinder 41 and front right (FR) (road (wheel)) wheel cylinder 43a. Normally open second shutoff (cutoff) valve 45j is installed between master cylinder 41 and front left (FL) (road (wheel)) wheel cylinder 43c. First shutoff valve 45e and second shutoff valve 45j are driven by solenoids 14e, 14j, respectively.

Brake liquid is supplied from a liquid reservoir 42 to first pump 15b and second pump 15d. This liquid reservoir 42 is connected to a reservoir tank 47. Brake liquid having a quantity by which once or three-times brakes can be generated at the respective wheel cylinders 43 (43a through 43d) by means of first pump 15b or second pump 15d is reserved in reservoir 42. A draining side of each of first pump 15b and second pump 15d is connected to each of wheel cylinders 43 (43a through 43d). A normally closed pressure increasing valve 45b is interposed between the draining side of each of fist pump 15b and second pump 15d and front right (FR) (road (wheel)) wheel cylinder 43a, a normally closed pressure increasing valve 45d is interposed between the draining side of each of first pump 15b and second pump 15d and rear left (RL) (road (wheel)) wheel cylinder 43b. A normally closed pressure increasing valve 45g is interposed between the draining side of each of first pump 15b and second pump 15d and front left (FL) (road (wheel)) wheel cylinder 43c. A normally closed pressure increasing valve 45i is interposed between the draining side of each of first pump 15b and second pump 15d and rear right (RR) (road (wheel)) wheel cylinder 43d. Each pressure increasing valve 45b, 45d, 45g, 45i is driven by means of a corresponding one of solenoids 14b, 14d, 14g, 14i.

A check valve 48 is interposed between first pump 15b and each of pressure increasing valves 45b, 45d, 45g, 45i to allow only a flow of the brake liquid in a draining direction of first pump 15b. Another check valve 49 is interposed between second pump 15d and each of pressure increasing valves 45b, 45d, 45g, 45i to allow only a flow of the brake liquid in the draining direction of second pump 15d.

A suction side of second pump 15d is connected to each of respective wheel cylinders 43 (43a through 43d). A normally closed pressure reducing valve 45a interposed between second pump 15d and front right (FR) (road (wheel)) wheel cylinder 43a. A normally closed pressure reducing valve 45c is interposed between second pump 15d and rear left (RL) (road (wheel)) wheel cylinder 43b. A normally closed pressure reducing valve 45f is interposed between second pump 15d and front left (FL) (road (wheel)) wheel cylinder 43c. A normally closed pressure reducing valve 45h is interposed between second pump 15d and rear right (RR) (road (wheel)) wheel cylinder 43d. Each pressure reducing valve 45a, 45c, 45f, 45h is driven by means of a corresponding one of solenoids 14a, 14c, 14f, 14h.

A piping between the draining side of each of first pump 15b and second pump 15d and each pressure increasing valve 45b, 45d, 45g, 45i is connected to the suction side of second pump 15d via a relief valve 46. A piping between master cylinder 41 and first shutoff valve 45e is connected via a normally closed stroke simulator cancel valve 16 to a stroke simulator 44 which provides a pseudo stroke for a brake pedal 40.

The piping between master cylinder 41 and first shutoff valve 45e and the piping between master cylinder 41 and second shutoff valve 45j are provided with a first master cylinder pressure (M/CYL) sensor 21b for detecting the brake liquid pressure generated by master cylinder 41 and a second master cylinder pressure (M/CYL) sensor 21c for detecting the same. Each of FR, RL, FL, RR (road (wheel)) wheel cylinders 43a, 43b, 43c, 43d is provided with a corresponding one of wheel cylinder pressure sensors 22a, 22b, 22c, 22d for detecting respective (road (wheel)) wheel cylinder (liquid) pressures. Master cylinder 41 is provided with a first stroke sensor 21a and a second stroke sensor 21d.

(Structure of Control Unit)

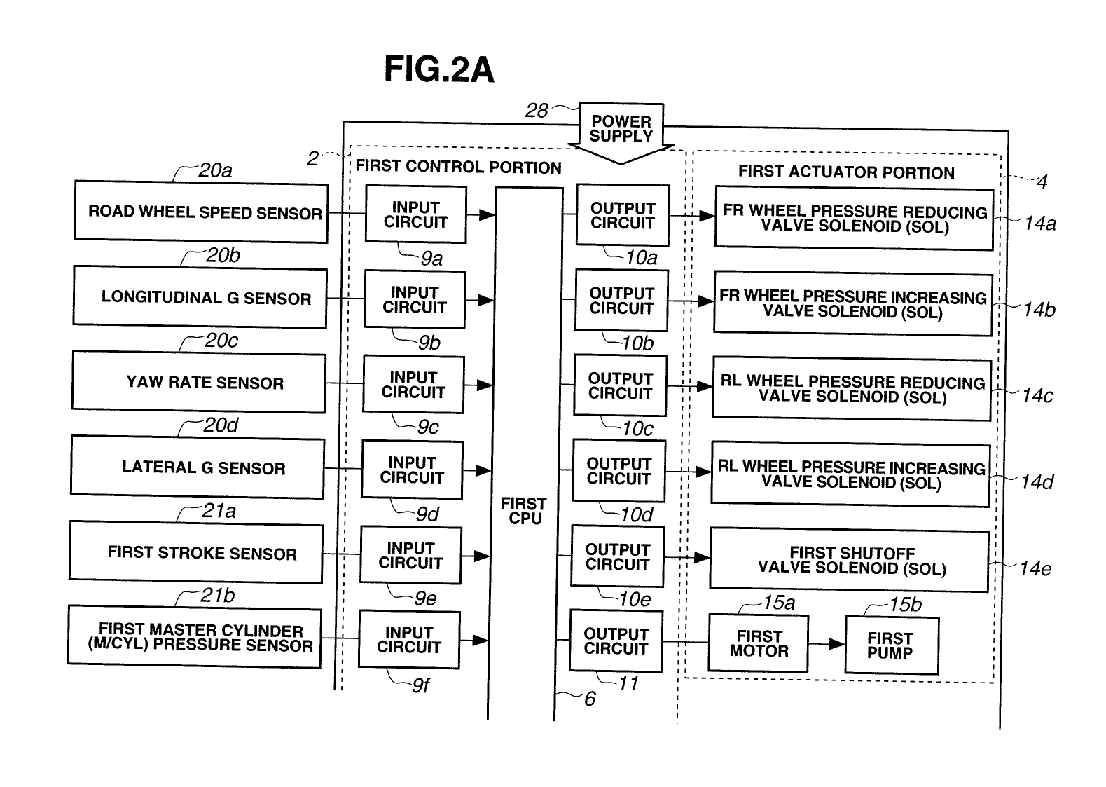

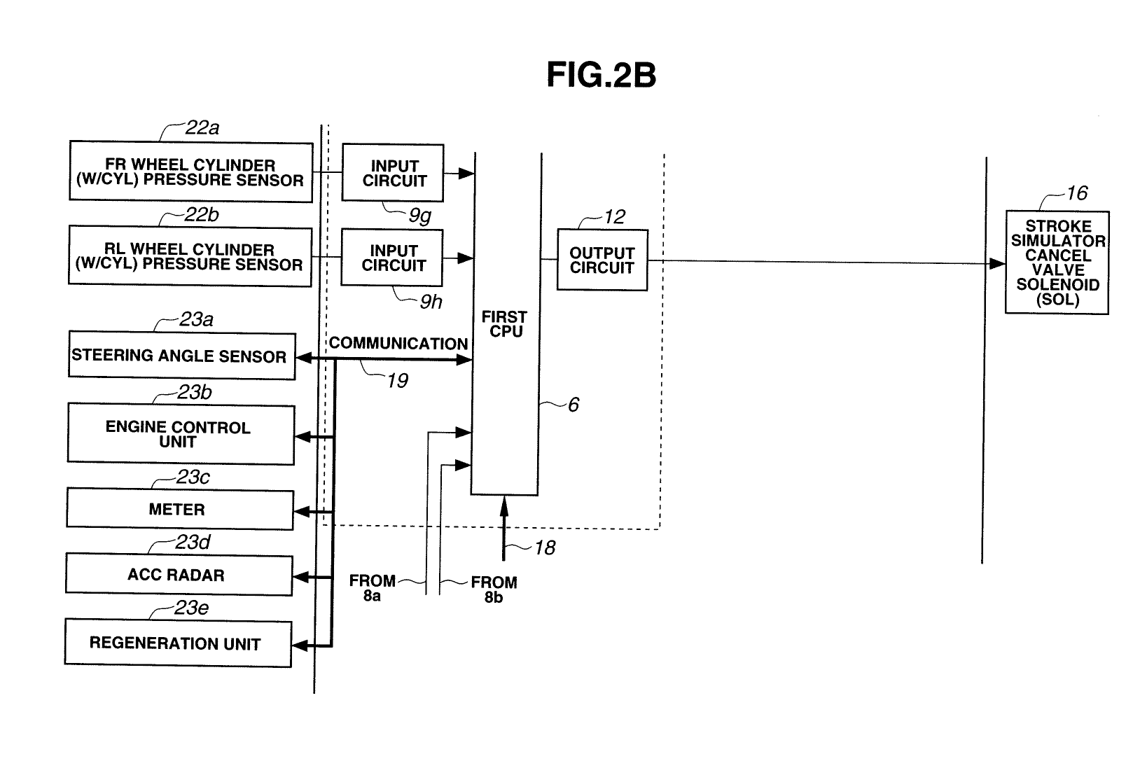

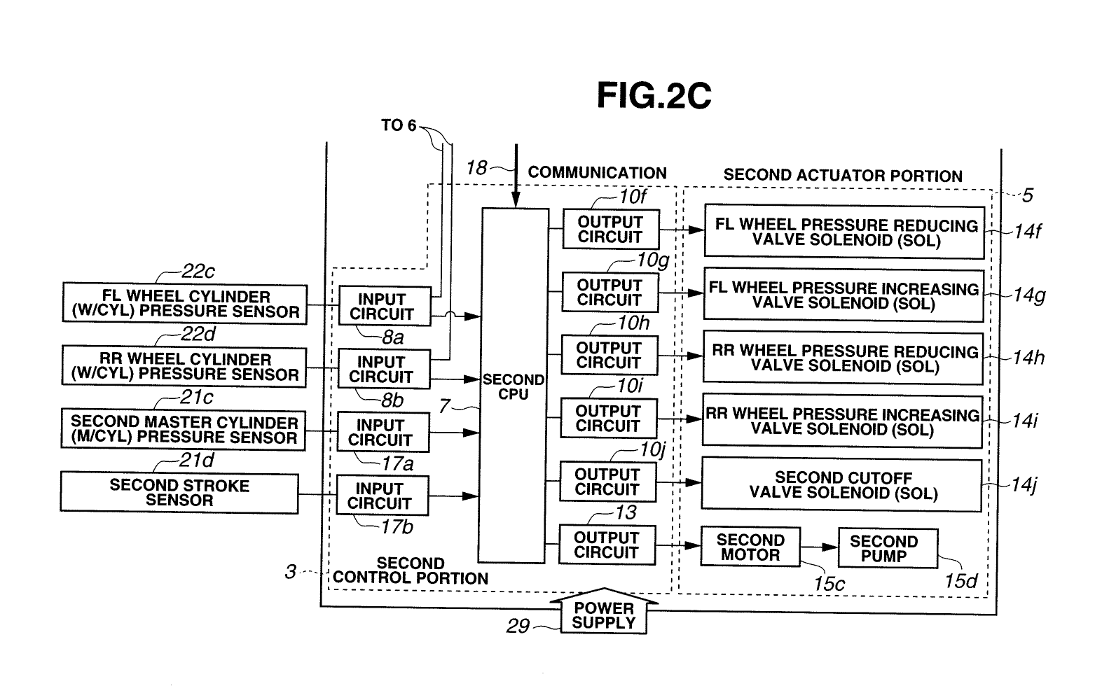

A structure of a control unit of brake liquid pressure control apparatus 1 will be described below. FIGS. 2A, 2B, and 2C integrally show a configuration view of a control unit of brake liquid pressure control apparatus 1 shown in FIG. 1. The control unit includes a first control portion 2 and a second control portion 3. First control portion 2 and second control portion 3 are mutually communicated with each other via a communication circuit 18. This communication circuit 18 is a communication circuit adopting a serial or parallel communication for performing a control brake force command transmission, a mutual CPU (Central Processing Unit) abnormality monitor, and so forth. An electricity (an electric power) is supplied to first control portion 2 from a power supply 28 and an electricity is supplied to second control portion 3 from another power supply 29. Two (DC, direct current) power supplies 28, 29 may be a common power supply to first control portion 2 and second control portion 3 or may be non-common independent power supplies.

A first actuator portion 4 includes a first liquid pressure control group having a front right (FR) (road (wheel)) wheel pressure reducing valve solenoid 14a (FR wheel pressure reducing valve solenoid (SOL)), a front right (FR) (road (wheel)) wheel pressure increasing valve solenoid 14b (FR wheel pressure increasing valve solenoid (SOL)), a rear left (RL) (road (wheel)) wheel pressure reducing valve solenoid 14c (RL wheel cylinder pressure reducing valve solenoid(SOL)), a rear left (RL) (road (wheel)) pressure increasing valve solenoid 14d (RR pressure increasing valve solenoid (SOL)), a first shutoff valve solenoid (first wheel pressure reducing valve SOL), and first liquid pressure generating means constituted by first motor 15a and first pump 15b. A second actuator portion 5 includes a second liquid pressure control group having a front left (FL) (road (wheel)) wheel pressure reducing valve solenoid 14f (FL wheel pressure reducing valve solenoid (SOL)); a front left (FL) (road (wheel) wheel pressure increasing valve solenoid 14g (FL wheel pressure increasing valve solenoid (SOL)), a rear right (RR) (road (wheel)) wheel pressure reducing valve solenoid 14h (RR wheel pressure reducing valve solenoid (SOL)), a rear right (RR) (road (wheel)) wheel pressure increasing valve solenoid 14i (RR wheel pressure increasing valve solenoid (SOL)), and a second shutoff valve solenoid 14j (second shutoff valve SOL), and second liquid pressure generating means constituted by second motor 15c and second pump 15d. It should be noted that first actuator portion 4 is integral with first control portion 2 or separated therefrom and second actuator portion 5 is integral with second control portion 3 or separated therefrom.

First control portion 2 has a first CPU 6 mainly performing a control and/or a calculation of liquid pressure of each of the wheel cylinders 43 (43a through 43d). This first CPU 6 ordinarily performs a vehicular brake control, an ABS (Anti-lock Brake System) control, a VDC (Vehicle Dynamic Control) control, and so forth on a basis of the information from each sensor as will be described later, transmits arithmetic operation (calculation) results to second control portion 3 and performs a driving control for first actuator portion 4 on a basis of the calculation results. It should be noted that first CPU 6 corresponds to an abnormality determining section according to a first invention and corresponds to the abnormality determining section according to a second invention, a third invention, and a fourth invention.

First CPU 6 inputs a (road) wheel speed information from a wheel speed sensor 20a for detecting a speed of each of the road wheels via an input circuit 9a, a longitudinal acceleration information from a longitudinal G sensor 20b for detecting a longitudinal acceleration of the vehicle via an input circuit 9b, a yaw rate information from a yaw rate sensor 20c for detecting a yaw rate of the vehicle via an input circuit 9c, a lateral acceleration information from a lateral G sensor 20d for detecting a lateral acceleration of the vehicle via an input circuit 9d, a stroke quantity information from first stroke sensor 21a via an input circuit 9e, a master cylinder pressure information from first master cylinder pressure sensor 21b (first M/CYL pressure sensor), a front right wheel (wheel) cylinder pressure information from front right (FR) (road (wheel)) wheel cylinder pressure sensor 22a (FR wheel W/CYL pressure sensor) via an input circuit 9g, a rear left (RL) (road (wheel)) wheel cylinder pressure information from rear left (RL) (road (wheel)) wheel cylinder pressure senor 22b (RL wheel W/CYL pressure sensor) via an input circuit 9h, and a rear right (RR) (road (wheel) wheel cylinder pressure information from rear right (RR) (road (wheel)) wheel cylinder pressure sensor 22d (RR wheel W/CYL pressure sensor) via an input circuit 8b.

In addition, first CPU 6 performs a mutual communication with a steering angle sensor 23a for detecting a steering angle of a vehicular steering wheel, an engine control unit (engine C/U) 23b for controlling an engine, various kinds of meters 23c, a radar (ACC (Adaptive Cruise Control radar) 23d for an automatic cruising of the vehicle, and a regeneration (braking) unit 23e, respectively, via a communication circuit 19.

First CPU 6 outputs a front right wheel pressure reducing valve drive signal via an output circuit 10a to front right (FR) (road (wheel)) wheel pressure reducing valve solenoid 14a, a front right pressure increasing valve drive signal via an output circuit 10b to front right (FR) (road (wheel)) wheel pressure increasing valve solenoid 14b, a rear left wheel pressure reducing valve drive signal via an output circuit 10c to rear left (RL) (road (wheel)) wheel pressure reducing valve solenoid 14c, a rear left wheel pressure increasing valve drive signal to rear left (RL) (road (wheel)) wheel pressure increasing valve solenoid 14d via an output circuit 10d, a first shutoff valve drive signal to first shutoff valve solenoid 14e via an output circuit 10e, a first pump drive signal via an output circuit 11 to first motor 15a, and a stroke simulator cancel valve drive signal to a stroke simulator cancel valve 16 via an output circuit 12.

Second control portion 3 includes a second CPU 7 mainly performing back-up control and back-up calculations. Second CPU 7 detects an wheel cylinder pressure information of the second liquid pressure control group, performs a monitoring of whether first CPU 6 operates normally or abnormally, performs a brake calculation for second actuator portion 5 on a basis of a control command issued from first CPU 6 while first CPU 6 is determined to operate normally, and performs a driving control of second actuator portion 5. It should be noted that second CPU 7 corresponds to an abnormality determining section in the first invention and corresponds to the abnormality determining section in the third invention and in the fourth invention.

Second CPU 7 inputs the wheel cylinder pressure information of the front left (FR) road wheel from front left (FR) (road (wheel)) cylinder pressure sensor 22c via an input circuit 8a, the wheel cylinder pressure information of the rear right (RR) road wheel from the rear right (RR) (road (wheel)) wheel pressure cylinder sensor 22d via an input circuit 8b, a master cylinder pressure information from second master cylinder pressure sensor 21c via an input circuit 17a, and a stroke quantity information from second stroke sensor 21d via an input circuit 17b.

Second CPU 7 outputs a front left (FL) wheel cylinder pressure reducing valve drive signal to front left (FL) (road (wheel)) wheel cylinder pressure reducing valve solenoid 14f via an output circuit 10f, a front left (FL) wheel pressure increasing valve drive signal to front left (FL) (road (wheel)) wheel pressure increasing valve solenoid 14g via an output circuit 10g, a rear right (RR) (road (wheel)) wheel pressure reducing valve drive signal to rear right (RR) (road (wheel)) wheel pressure reducing valve solenoid 14h via an output circuit 10h, a rear right wheel cylinder pressure increasing valve drive signal to rear right (RR) (road (wheel)) wheel cylinder increasing valve solenoid 14i via an output circuit 10i, a second shutoff valve drive signal to second shutoff valve solenoid 14j via an output circuit 10j, and a second pump drive signal to second motor 15c via an output circuit 13.

[Structure of Control Circuit of Solenoid Valve]

Brake liquid pressure control apparatus 1 in the embodiment performs the liquid pressure control, dividing the liquid pressure control groups into the first liquid pressure control group and the second liquid pressure control group.

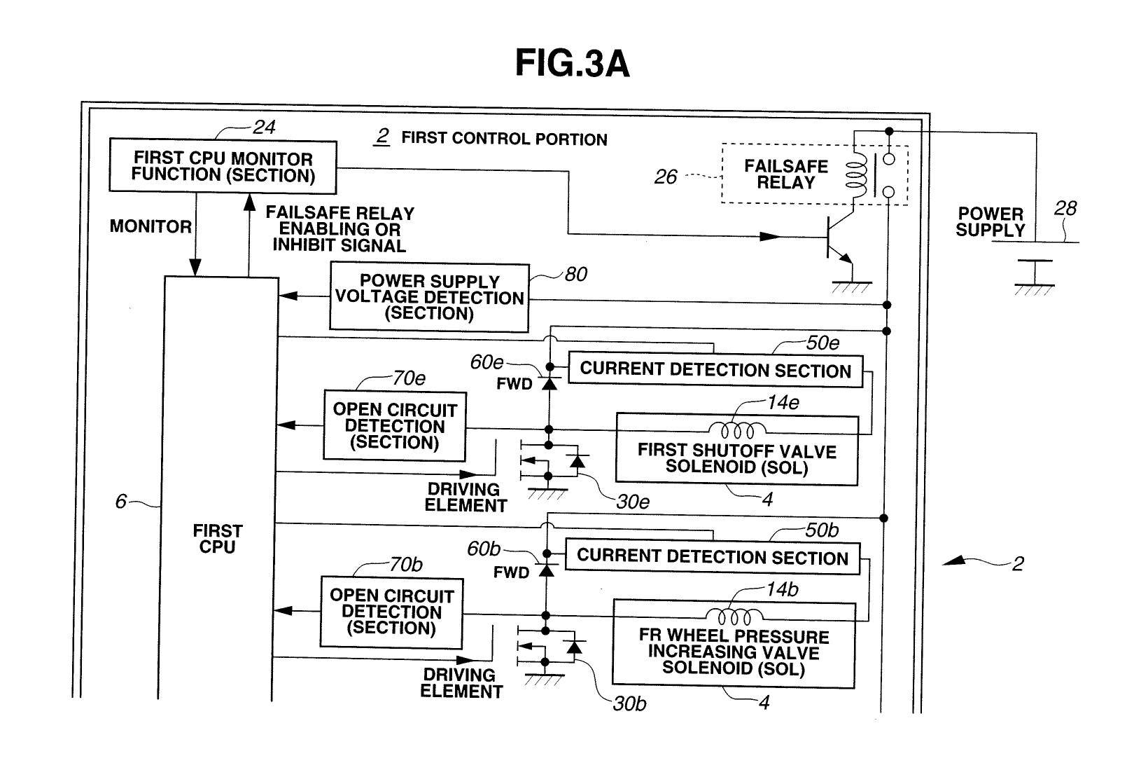

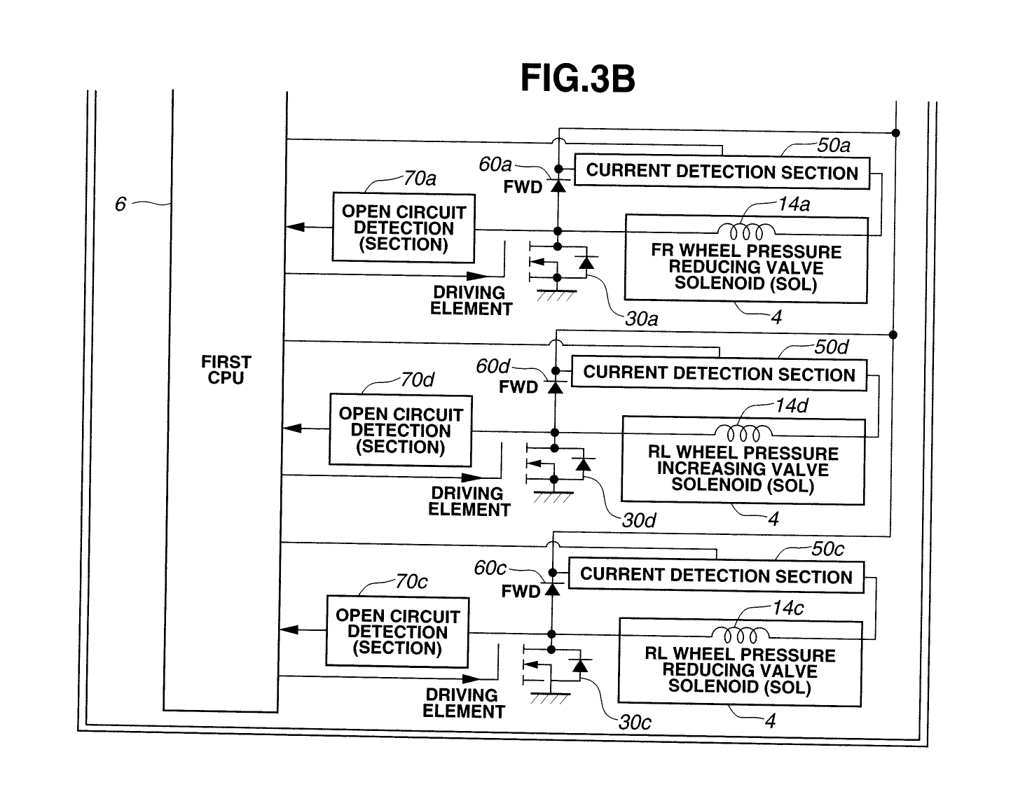

FIGS. 3A and 3B integrally show a control circuit structure of the first liquid pressure control group. A failsafe relay (F/S relay) 26 is interposed between power supply 28 and each solenoid 14a, 14b, 14c, 14d, 14e of the first liquid pressure control group. Driving elements 30a, 30b, 30c, 30e are installed between respective solenoids 14a, 14b, 14c, 14d, 14e and the ground to drive respectively corresponding solenoids 14a, 14b, 14c, 14d, 14e. Flywheel diodes (FWD) 60a, 60b, 60c, 60e are installed in parallel to respective solenoids 14a, 14b, 14c, 14d, 14e.

It should be noted that failsafe relay 26 corresponds to a first switching element in the first invention and in the fifth invention and corresponds to a power supply relay in the second invention, in the third invention, and in the fourth invention. Driving elements 30a, 30b, 30c, 30d, 30e correspond to second switching element in the first invention and in the fifth invention and correspond to switching elements in the second invention, in the third invention, and in the fourth invention. Each of solenoids 14a, 14b, 14c, 14d, 14e correspond to a load in the first invention, in the second invention, in the third invention, and in the fifth invention, and correspond to a coil in the fourth invention.

A power supply voltage detection section 80 is interposed between failsafe relay 26 and each of solenoids 14a, 14b, 14c, 14d, 14e. In addition, current detection sections 50a, 50b, 50c, 50d, 50e are installed between power supply voltage detection section 80 and respective solenoids 14a, 14b, 14c, 14d, 14e. Open circuit detection sections 70a, 70b, 70c, 70d, 70e are disposed between respective solenoids 14a, 14b, 14c, 14d, 14e and respective driving elements 30a, 30b, 30c, 30d, 30e.

It should be noted that each of current detection sections 50a, 50b, 50c, 50d, and 50e correspond to current detecting means in the first invention and correspond to a current monitoring section in the second invention, in the second invention, and in the fourth invention. Open circuit detection sections 70a, 70b, 70c, 70d, 70c, 70d, 70e correspond to voltage detecting means in the first invention and correspond to a circuit voltage monitoring section in the second invention, in the third invention, and in the fourth invention. Power supply voltage detection section 80 corresponds to power supply voltage monitoring means in the first invention and corresponds to a power supply voltage monitoring section in the second invention, in the third invention, and in the fourth invention.

First CPU 6 inputs a power supply voltage value information from power supply voltage detection section 80 in a form of an analog signal and uses the power supply information for the control and abnormality diagnosis after an A/D (Analog-to-Digital conversion) process. In addition, first CPU 6 inputs current value information from current detection sections 50a, 50b, 50c, 50d, 50e in the form of the analog signal or a communication signal to be used for the control and abnormality diagnosis after the A/D conversion process or after a receipt data process. In addition, first CPU 6 inputs an open circuit (wire breakage or so forth) detection information from the open circuit detection sections 70a, 70b, 70c, 70d, 70e in the form of the analog signal or HI/L0 signal and uses directly the value itself of the A/D conversion process or the HI/LO signal for the abnormality diagnosis.

Failsafe relay 26 is controlled by means of a first CPU monitor function section 24. First CPU 6 outputs a power supply application enabling (allowing) or inhibit signal of failsafe relay 26 to first CPU monitor function section 24. First CPU 6 outputs the power supply application enabling (allowing) signal to first CPU monitor function portion 24 to turn on failsafe relay 26 during an initialization process executed therein. On the other hand, first CPU 6 executes a predetermined diagnosis sequence and outputs the power supply application inhibit signal to first CPU monitor function section 24 when determining that it is necessary to open (turn off) failsafe relay 26.

Power supply voltage detection section 80 detects the voltage value of power supply 28 and inputs the power supply voltage information to first CPU 6. First CPU 6, then, grasps the voltage supplied to each of solenoids 14a, 14b, 14c, 14d, 14e of the first liquid pressure control group from this voltage information to be reflected on the brake liquid pressure control and calculations. Current detection sections 50a, 50b, 50c, 50d, 50e detect current values flowing into respective solenoids 14a, 14b, 14c, 14d, 14e of the first liquid pressure control group and inputs the current value information to first CPU 6. Current detection sections 50a, 50b, 50c, 50d, 50e are current sensors, each current sensor being constituted by a shunt resistor, a differential amplifier, and so forth, and current-to-voltage conversion signals thereof are transmitted to first CPU 6 in the form of analog signals or serial communication signals. First CPU 6 performs a feedback control for calculating drive signals for respective solenoids 14a, 14b, 14c, 14d, 14e in accordance with the current values of respective solenoids 14a, 14b, 14c, 14d, 14e.

Open circuit detection sections 70a, 70b, 70c, 70d, 70e detect voltage values located at downstream sides of respective solenoids 14a, 14b, 14c, 14d, 14e of the first liquid pressure control group and supplies the current value information to first CPU 6. First CPU 6 determines a high level (HI) if the voltage value information from open circuit detection sections 70a, 70b, 70c, 70d, 70e is equal to or larger than a threshold (voltage) value from the voltage value information of corresponding open circuit detection section 70a, 70b, 70c, 70d, 70e and determines a low level (LO) if the voltage value information from open circuit detection sections 70a, 70b, 70c, 70d, 70e is smaller than the threshold (voltage) value. This threshold (voltage) value may be set to a value used to determine whether the voltage values of respective solenoids 14a, 14b, 14c, 14d, 14e at the downstream sides thereof correspond to a power supply voltage value of power supply 28 or correspond to (equivalent to) the ground potential and may be set to approximately three volts [v].

Driving elements 30a, 30b, 30c, 30d, 30e perform switching operations of passing currents through respective solenoids 14a, 14b, 14c, 14d, 14e of the first liquid pressure control group through corresponding drive signals outputted from first CPU 6. These driving elements 30a, 30b, 30c, 30d, 30e are constituted by semiconductor devices such as Field Effect transistors (FETs) or power transistors. Flywheel diodes 60a, 60b, 60c, 60d, 60e serve to flow back inductive energies of respective solenoids 14a, 14b, 14c, 14d, 14e of the first liquid pressure control group.

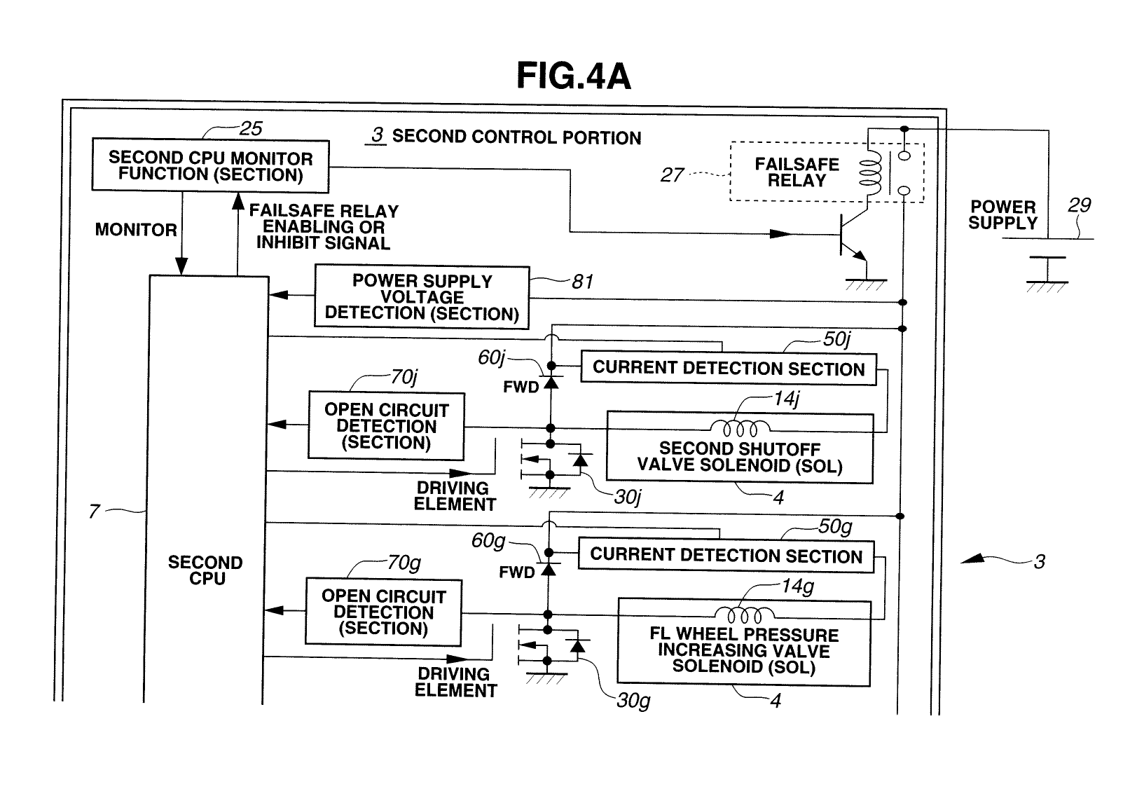

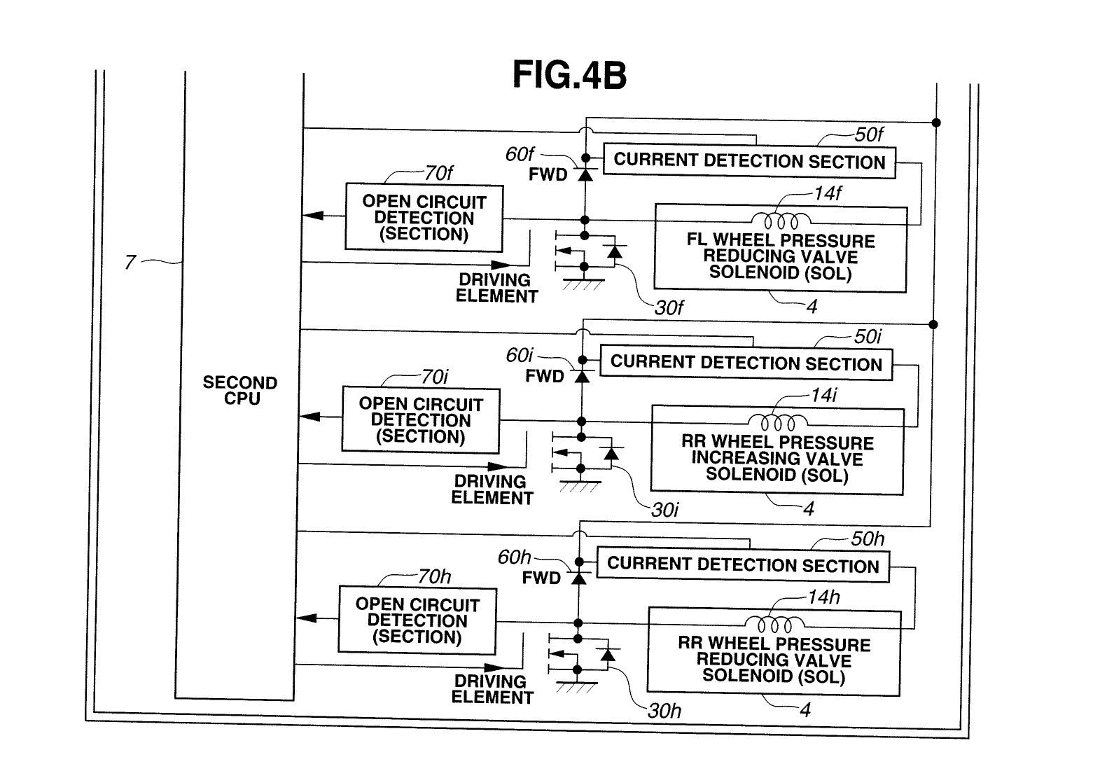

FIGS. 4A and 4B integrally show a structure of a control circuit of the second liquid pressure control group. A failsafe relay (F/S relay) 27 is installed between power supply 29 and each solenoid 14f, 14g, 14h, 14i, 14j of the second liquid pressure control group. Each solenoid 14f, 14g, 14h, 14i, 14j is provided with each of driving elements 30f, 30g, 30h, 30i, 30j to drive the corresponding one of respective solenoids 14f, 14g, 14h, 14i, 14j. In addition, flywheel diodes (FWD) 60f, 60g, 60h, 60j are installed in parallel to respective solenoids 14f, 14g, 14h, 14i, and 14j.

It should be noted that failsafe relay 27 corresponds to the first switching element in the first invention and in the fifth invention and a power supply relay in the second invention, in the third invention, and in the fourth invention. In addition, each of driving elements 30f, 30g, 30h, 30i, 30j corresponds to the second switching element in the first invention and in the fifth invention and corresponds to the switching element in the third invention and in the fifth invention. In addition, each of solenoids 14a, 14b, 14c, 14d, 14e corresponds to the load in the first invention and in the fifth invention and correspond to the coil in the fourth invention.

A power supply voltage detection section 81 is interposed between failsafe relay 27 and each solenoid 14f, 14g, 14h, 14i, and 14j. In addition, current detection sections 50f, 50g, 50h, 50i, 50j are interposed between power supply voltage detection section 81 and respective solenoids 14f, 14g, 14h, 14i, 14j, respectively. Open circuit detection sections 70f, 70g, 70h, 70i, 70j are interposed between respective solenoids 14f, 14g, 14h, 14i, and 14j and respective driving elements 30f, 30g, 30g, 30i, 30j.

It should be noted that each of current detection sections 50f, 50g, 50h, 50i, 50j corresponds to current detecting means in the first invention and corresponds to the current monitoring section in the second invention, in the third invention, and in the fourth invention. In addition, power supply voltage detection section 81 corresponds to power supply voltage monitoring means in the first invention and corresponds to the power supply voltage monitoring section in the second invention, in the third invention, and in the fourth invention.

Second CPU 7 inputs the power supply voltage value information from power supply voltage detection section 81 in the form of the analog signal and uses it for the later control and abnormality diagnosis after the A/D conversion process. Second CPU 7 receives the current value information from current detection sections 50f, 50g, 50h, 50i, 50j in the form of the analog signal or communication signal after the A/D conversion process or after the process of the received data. Second CPU 7 receives the open circuit detection information from open circuit detection sections 70f, 70g, 70h, 70i, 70j in the form of the analog signal or in the form of HI (level) or LO (level) signal. Second CPU 7 uses the digital value after the A/D conversion thereof, or the signal of the conversion in the HI/L0 signal or direct value of the input signal for the later abnormality diagnosis.

Failsafe relay 27 is controlled by means of a second CPU monitor function section 25. Second CPU 7 outputs the power supply (voltage) application enabling (allowing) or the power supply (voltage) application inhibit signal for failsafe relay 27 to second CPU monitor function section 25. Second CPU 7 outputs the power supply application enabling (allowing) signal to second CPU monitor function section 25 to turn on failsafe relay 27 during the initialization process thereof. On the other hand, when a predetermined diagnosis sequence is executed and, when second CPU 7 determines that it is necessary to open (turn off) failsafe relay 27, second CPU 7 outputs the power supply application inhibit signal to second CPU monitor function section 25 to turn off failsafe relay 27. Power supply voltage detection section 81 detects the voltage value of power supply 29 and inputs the power supply voltage information to second CPU 7. Power supply voltage detection section 81 detects the power supply voltage value of power supply 29 and inputs the power supply voltage information to second CPU 7. Second CPU 7 grasps the voltage supplied to each solenoid 14f, 14g, 14i, 14j of the second liquid pressure control group from the power supply information and reflects the voltage value information supplied on the later liquid pressure control and calculation.

Current detection sections 50f, 50g, 50h, 50i, 50j detect the current values flowing into respective solenoids 14f, 14g, 14h, 14i, 14j of the second liquid pressure control group and input the current value information to second CPU 7. Current detection sections 50f, 50g, 50h, 50i, 50j are the current sensors, each current sensor being constituted by the shunt resistor, the differential amplifier, and so forth, and transmit the current-to-voltage conversion signals to second CPU 7 in the form of the analog signals or the serial communication signals. Second CPU 7 performs the feedback control which calculates the drive signals for respective solenoids 14f, 14g, 14h, 14i, 14j in accordance with the current values flowing into respective solenoids 14f, 14g, 14h, 14i, 14j.

Open circuit detection sections 70f, 70g, 70h, 70i, 70j detect voltage values located at downstream sides of respective solenoids 14f, 14g, 14h, 14i, 14j of the second liquid pressure control group and supplies the current value information to second CPU 7. Second CPU 7 determines the high level (HI) if the voltage value information from open circuit detection sections 70f, 70g, 70h, 70i, 70j is equal to or larger than a threshold (voltage) value from the voltage value information of corresponding open circuit detection section 70f, 70g, 70h, 70i, 70j and determines the low level (LO) if the voltage value information from open circuit detection sections 70f, 70g, 70h, 70i, 70j is smaller than the threshold (voltage) value. This threshold (voltage) value may be set to a value used to determine whether the voltage values of respective solenoids 14f, 14g, 14h, 14i, 14j at the downstream sides thereof correspond to a power supply voltage value of power supply 29 or correspond to (equivalent to) the ground potential and may be set to approximately three volts [v].

Open circuit detection sections 70f, 70g, 70h, 70i, 70j may correspond to the analog-to-digital conversion function of second CPU 7 or may, alternatively, be used as power supply voltage detection section 81. In this alternative case, any one or more of open circuit detection sections 70f, 70g, 70h, 70i, 70j corresponding to solenoids 14f, 14g, 14h, 14i, 14j which are under no control from among respective solenoids 14f, 14g, 14h, 14i, 14j serve to detect the power supply voltage.

Driving elements 30f, 30g, 30h, 30i, 30j perform switching actions of current flowing into respective solenoids 14f, 14g, 14h, 14i, 14j of the second liquid pressure group in response to drive signals from second CPU 7. These driving elements 30f, 30g, 30h, 30i, 30j are constituted by semiconductor devices such as Field Effect transistors (FETs), power transistors, and so forth. Flywheel diodes 60f, 60g, 60h, 60i, 60j serve to flow back inductive energies of respective solenoids 14f, 14g, 14h, 14i, 14j of the second liquid pressure group.

[Action of Brake-By-Wire System]

Brake liquid pressure control apparatus 1 acts ordinarily as a brake-by-wire system. That is to say, at a time of an ordinary braking, first shutoff valve 45e and second shutoff valve 45j are (valve) closed, stroke simulator cancel valve 16 is (valve) opened, and the liquid pressure is supplied to each of wheel cylinders 43 (43a through 44d) by means of first pump 15b and second pump 15d (a, so-called, power boosted brake). In a case where first shutoff valve 45e and second shutoff valve 45j are (valve) opened, stroke simulator cancel valve 16 is (valve) closed, and the liquid pressure is supplied to front left and right road (FL, FR) (road (wheel)) wheel cylinders 43a, 43c by means of master cylinder 41 (a, so-called, leg-power brake (depression force through brake pedal 40)).

Brake liquid pressure control apparatus 1 is designed to be enabled to perform the power boosted brake as far as possible even if the abnormality (failure) occurs in some part of brake liquid pressure control apparatus 1. For example, brake liquid pressure control apparatus 1 is provided with the two liquid pressure generation sources of first motor 15a and first pump 15b and second motor 15c and second pump 15d, the power boosted brake can be performed by means of one of the two liquid pressure sources of the pump and the motor even if the abnormality of the other of the two liquid pressure generation sources of the pump and the motor occurs. In addition, even if the abnormality of at least one part of proportional solenoid valves 45 (45a, 45b, 45c, 45d, 45e, 45f, 45g, 45h, 45i, 45j) occurs, the power boosted brake can be performed for any other corresponding wheel cylinders 43 (43a through 43d) than one of the wheel cylinders 43 (43a through 43d) corresponding to a location at which the abnormality occurs. It should be noted that, in a case where the abnormality occurs in one of proportional solenoid valves 45 (45a through 45d, 45f through 45i) corresponding to front right and left (FR, FL) (road (wheel)) wheel cylinders 43a, 43c, the leg-power brake can be performed for front right and left (FR, FL) (road (wheel)) wheel cylinders 43a, 43c.

In addition, in a case where such an abnormality that an over-current is caused to flow due to a short to ground (fault) to generate heat, there is often a case where failsafe relay 26, 27 is turned off to stop the power supply application from power supply 28, 29 and only the leg-power brake described above is unavoidably performed.

In order to perform the power boosted brake as far as possible even if the abnormality occurs in part of brake liquid pressure control apparatus 1 and in order to perform only the leg-power brake if such the abnormality as to generate heat occurs, it is necessary to specify (or determine) a location at which the abnormality occurs and a kind of the abnormality. Then, in brake liquid pressure control apparatus 1 in this embodiment, power supply 28, 29 and solenoids 14 (14a through 14j), failsafe relays 26, 27, driving elements 30 (30a through 30j), current detection section 50 (50a through 50j), power supply voltage detection sections 80, 81, and open circuit detection section 70 (70a through 70j) are arranged as shown in FIGS. 3A and 3B and FIGS. 4A and 4B. Then, on a basis of monitoring results of the current state detected by means of current detection section 50, the voltage state detected by means of open circuit detection section 70, and the voltage state detected by means of power supply voltage detection sections 80, 81, the abnormality location or the abnormality kind is determined (or specified). Hereinafter, processes of the abnormality detection will be described in details.

[Failure Mode and Abnormality Detection Result]

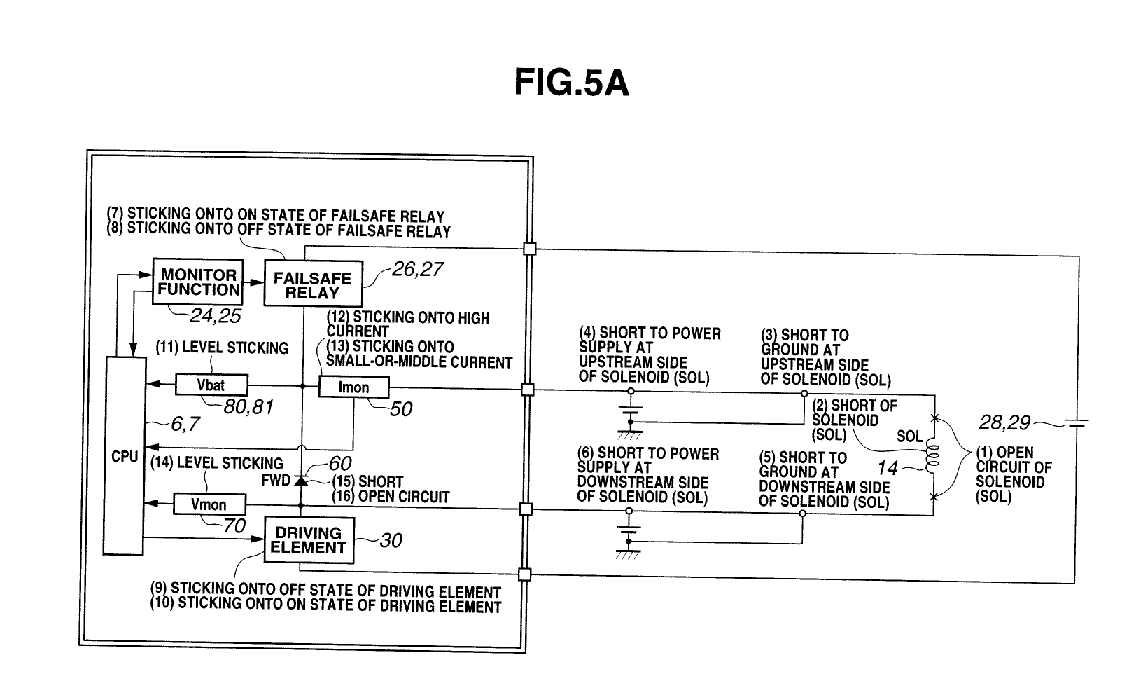

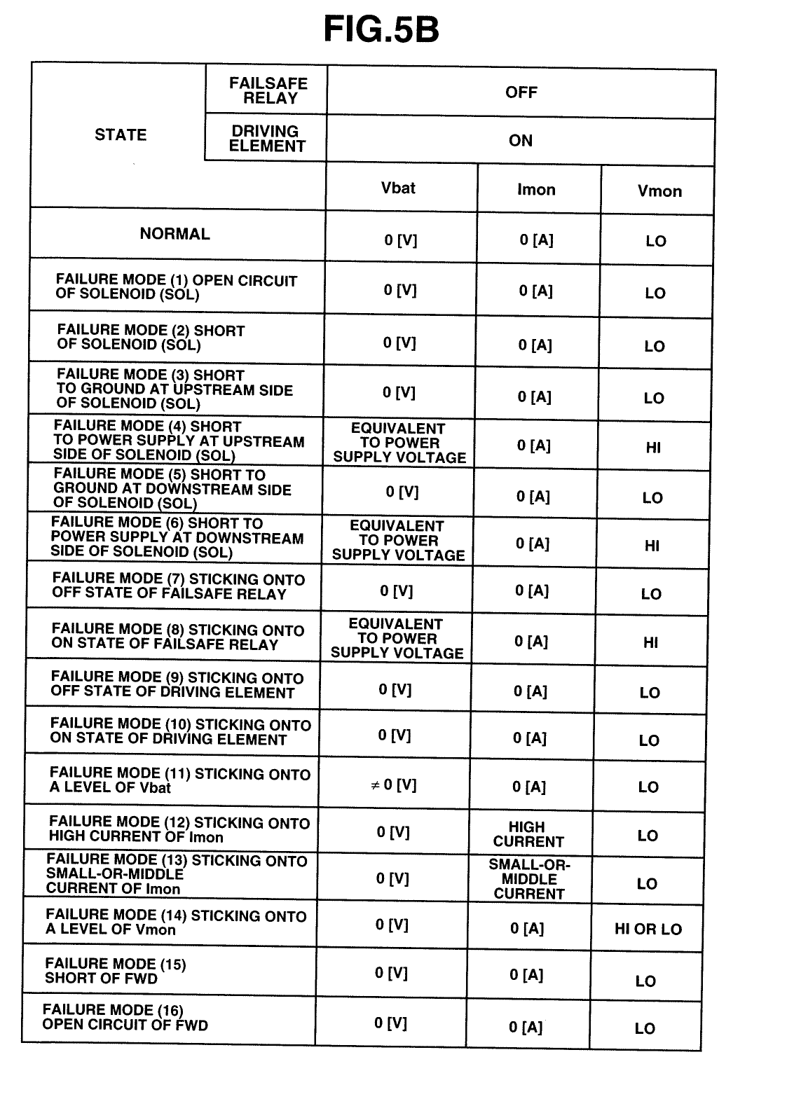

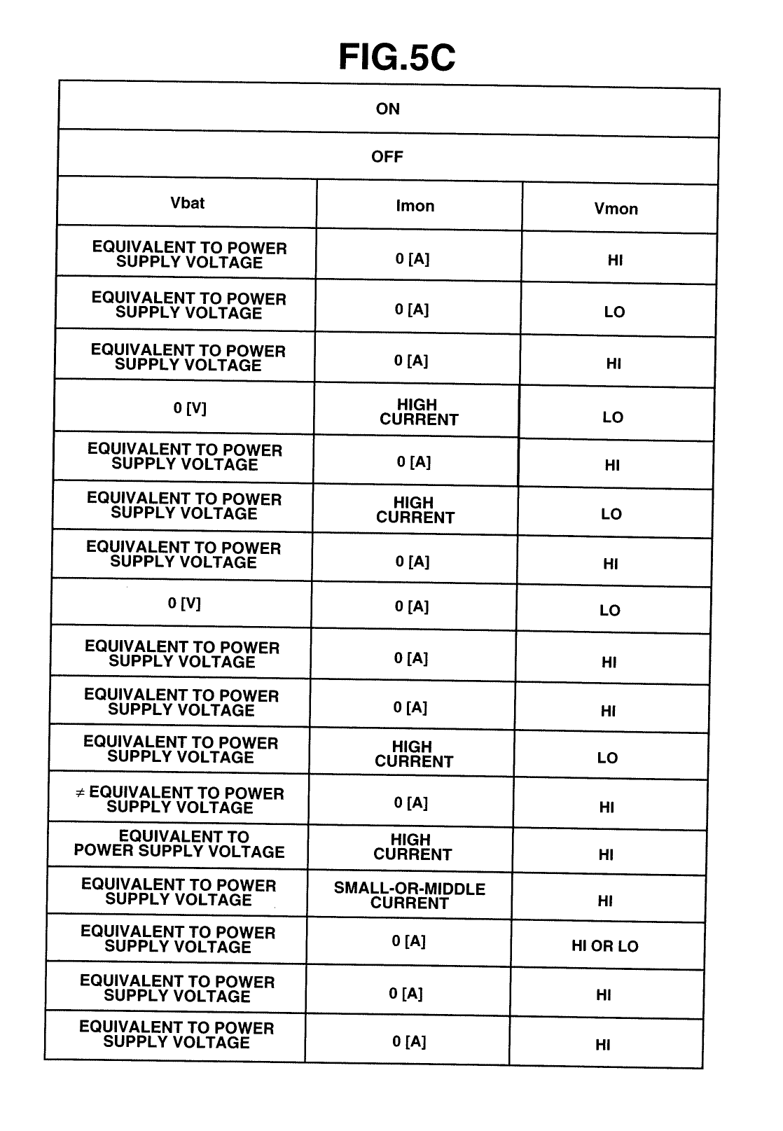

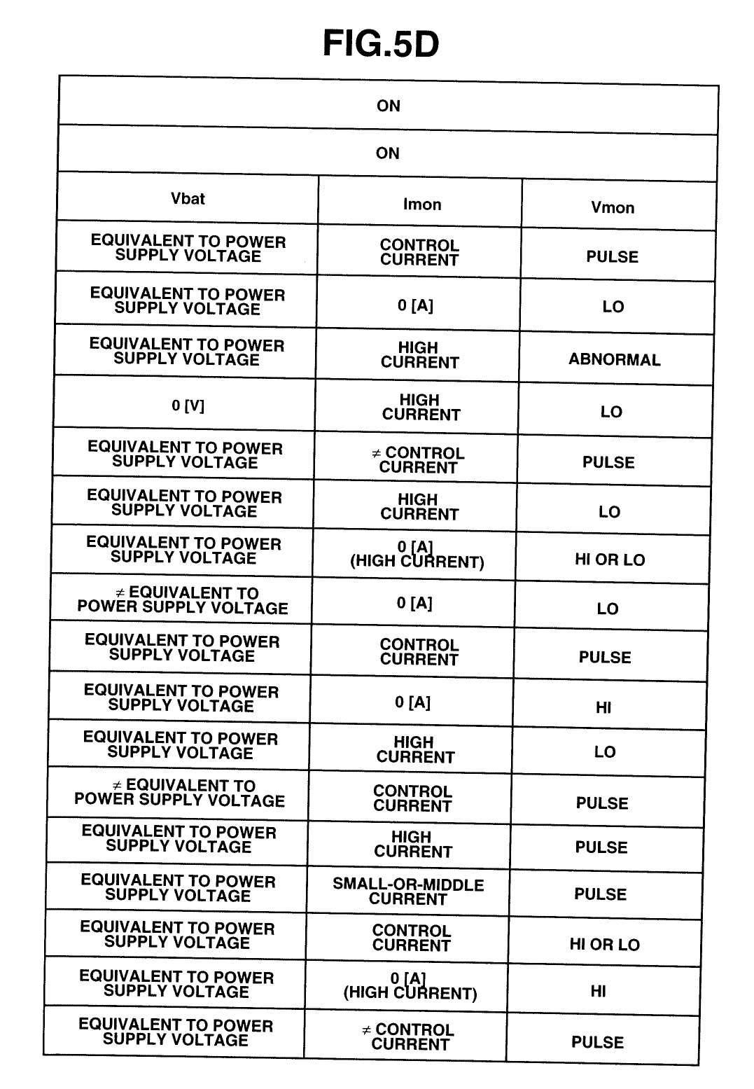

FIG. 5A shows a schematic diagram illustrating a control circuit structure of representative solenoid 14 (14a through 14j) and FIGS. 5B, 5C, and 5D integrally show a table (continued in a rightward direction of sheets of paper) representing the results of detection values of respective detection sections described above corresponding to respective failure modes in relation to FIG. 5A. The failure detections are carried out at the following three timings (a), (b), and (c) according to a combination of on-and-off states of failsafe relay 26, 27 and on-and-off states of a representative driving element 30. In FIG. 5A, (1) through (16) indicate first through sixteenth failure modes as will be described later.
(a) During the off state of failsafe relay 26, 27, (viz., during the initialization process, the failure detection is carried out).
(b) During the on state of failsafe relay 26, 27 and while driving element 30 is in an off state (turned off), (viz., the failure detection is carried out during the initialization process and during the control process).
(c) During the on state of failsafe relay 26, 27 and while driving element 30 is in an on state (turned on) (viz., the failure detection is carried out during the initialization process and during the control process).

It should be noted that the initialization process indicates a process such that, if an activation condition of the brake-by-wire system is established (for example, when a vehicular door lock is released or when an ignition switch of the vehicle is turned on), the control unit is activated and executes various kinds of initial settings and operation checks. Failsafe relay 26, 27 is transferred from the off state to the on state during this initialization process. In addition, the control process described above indicates an non-control state in which a brake request (demand) is not generated and a control state in which the braking request (demand) is generated.

One of the failure modes is specified from the combination of three detection values of detection value Vbat of power supply voltage detection section 80, 81 and detection value Imon of current detection section 50, and detection value Vmon of open circuit detection section 70. Detection results of respective detection sections during a normal state and according to the failure modes will, hereinafter, be described.

<Normal State>
(a) Failsafe relay: off.
   Vbat=0 [V], Imon=0 [A], Vmon=LO.
(b) Failsafe relay: on, driving element: off.
   Vbat=equivalent (corresponds) to the power supply voltage, Imon=0 [A], Vmon=HI.
(c) Failsafe relay: on, driving element on.
   Vbat=equivalent to the power supply voltage, Imon=control current, Vmon=pulse.

It should be noted that, when the detection values of the respective detection sections indicate the above-described states, the whole parts under the failure detection are in, so-called, standard states and, when the detection values thereof are out of the above-described standard states (nonstandard states), the failure (the abnormality) in any one or more of the parts under the failure detection occurs.

<Failure Mode (1): Open Circuit of Solenoid (SOL)>

This is a first failure mode in which either or both ends of solenoid 14 is broken (open circuit) due to either or both ends of solenoid (SOL) 14 being in a soldering failure, due to a connector contact failure, or due to other causes. Consequently, during the control process, the supply of the power to the corresponding solenoid 14 cannot be preformed.
(a) Failsafe relay: off.
   Vbat=0 [V], Imon=0 [A], Vmon=LO.
(b) Failsafe relay: on, driving element: off.
   Vbat=equivalent to the power supply voltage, Imon=0 [A], Vmon=LO.

Since the power supply voltage is not applied to open circuit detection section 70, Vmon=LO and this result indicates that the corresponding part (solenoid) is nonstandard.
(c) Failsafe relay: on, driving element: on.
   Vbat=equivalent (corresponds) the power supply voltage, Imon=0 [A], Vmon=pulse.

Since the power supply to solenoid 14 cannot be performed, Imon=0 [A] and this result indicates that the corresponding part (solenoid 14) is nonstandard.

<Failure Mode (2): Short (or also Called, a Short-Circuit) of Solenoid (SOL)>

This is a second failure mode in which a resistance value of solenoid 14 is remarkably reduced due to a wire contact between both ends of solenoid 14. In this mode, a short current (a short-circuit (or a high) current) is caused to flow during the control process.
(a) Failsafe relay: off.
   Vbat=0 [V], Imon=0 [A], Vmon=LO.
(b) Failsafe relay: on, driving element: off.
   Vbat=equivalent to the power supply voltage, Imon=0 [A], Vmon=HI.
(c) Failsafe relay: on, driving element: on.
   Vbat=equivalent (corresponds) to the power supply voltage, Imon=high current, Vmon=abnormal value.

Imon=high current due to the flow of the short-circuit current (the high current), indicating that that the corresponding part (solenoid 14) under the failure detection is nonstandard.

<Failure Mode (3): A Short to Ground (Fault) at an Upstream (Side) of Solenoid (SOL)>

This is a third failure mode in which an upstream side of solenoid 14 is contacted to the ground due to a harness wrapping of a vehicular harness around the upstream side of solenoid 14 or due to the contact of the upstream side thereof with a bus bar (wiring) connected to power supply 28, 29. In this failure mode, the short current (the high current) is caused to flow from power supply 28, 29.
(a) Failsafe relay: off.
   Vbat=0 [V], Imon=0 [A], Vmon=LO.
(b) Failsafe relay: on, driving element: off.
   Vbat=0 [V], Imon=high current, Vmon=LO.
(c) Failsafe relay: on, driving element: on.
   Vbat=0 [V], Imon=high current, Vmon=LO.

Vbat=0 [V] under each condition (a), (b), and (c) and indicates that the corresponding part under the failure detection is nonstandard due to the short to ground (fault) at the upstream side of solenoid 14. In addition, Vmon=LO under each condition (a), (b), and (c) and indicates that the corresponding part under the failure detection is nonstandard due to the short to ground (fault) at the upstream side of solenoid 14.

<Failure Mode (4): A Short to Power Supply (Fault) at the Upstream (Side) of Solenoid (SOL)>

This is a fourth failure mode in which the upstream side of solenoid 14 is contacted with power supply 28, 29 due to the harness wrapping of the vehicular harness around the upstream side of solenoid 14 and the contact of the bus bar wiring to the upstream side of solenoid 14. There is a possibility that, during the control process, the control current is caused to flow from the location at which the short to power supply (fault) occurs.
(a) Failsafe relay: off.
   Vbat=equivalent (corresponds) to the power supply voltage, Imon=0 [A], Vmon=HI.

Since Vbat=equivalent (corresponds) to the power supply voltage and Vmon=HI, the corresponding part under the failure detection is nonstandard.
(b) Failsafe relay: on, driving element: off.
   Vbat=equivalent (corresponds) to the power supply voltage, Imon=0 [A], Vmon=HI.
(c) Failsafe relay: on, driving element: on.
   Vbat=equivalent (corresponds) to the power supply voltage, Imon≠control current, Vmon=pulse.

Since a flow back current is only caused to flow into current detection section 50, Imon≠control current which indicates that the corresponding part under the failure detection is nonstandard.

<Failure Mode (5): The Short to Ground (Fault) at the Downstream Side of Solenoid (SOL)>

This is a fifth failure mode in which the downstream side of solenoid 14 is contacted onto the ground (GND) due to the harness wrapping of the vehicular harness around the downstream side of solenoid 14, the contact of the downstream side of solenoid 14 to the bus bar wiring, or so forth. The power is always supplied to solenoid 14.
(a) Failsafe relay: off.
   Vbat=0 [V], Imon=0 [A], Vmon=LO.
(b) Failsafe relay: on, Driving element=off.
   Vbat=equivalent (corresponds) to the power supply voltage, Imon=high current, Vmon=LO.
(c) Failsafe relay: on, driving element: on.
   Vbat=equivalent to the power supply voltage, Imon=high current, Vmon=LO.

Since the high current is always caused to flow into solenoid 14 irrespective of controlled variables, Imon=high current (not the control current) and this indicates that the corresponding part under the failure detection is nonstandard. Vmon=LO due to the short to ground (GND) at the downstream side of solenoid 14 and this indicates that the corresponding part under the failure detection is nonstandard.

<Failure Mode (6): The Short to Power Supply (Fault) at the Downstream Side of Solenoid (SOL)>

This is a sixth failure mode in which the downstream side of solenoid 14 is contacted to power supply 28, 29 due to the harness wrapping of the vehicular harness around the downstream side of solenoid 14 and the contact of the bus bar wiring onto the downstream side of solenoid 14.
(a) Failsafe relay: off.
   Vbat=equivalent (corresponds) to the power supply voltage, Imon=0 [A], Vmon=HI.

Vbat=equivalent (corresponds) to the power supply voltage and Vmon=HI, these results indicating that the corresponding part under the failure detection is nonstandard.
(b) Failsafe relay: on, driving element: on.
   Vbat=equivalent (corresponds) to the power supply voltage, Imon=0 [A], Vmon=HI.
(c) Failsafe relay: on, driving element; on.
   Vbat=equivalent to the power supply voltage, Imon=0 [A], Vmon=HI or LO.

Since no current is always caused to flow into solenoid 14, Imon=0 [A] and this result indicates that the corresponding part under the failure detection is nonstandard. Since a certain-level voltage is always applied to open circuit detection section 70 from the location at which the short to power supply (fault) occurs, there is a possibility of the corresponding part being nonstandard since Vmon=HI. However, there is often a case where driving element 30 is turned on, Vmon=LO and this result indicates nonstandard. Even in either case, solenoid 14 becomes an uncontrollable state (cannot be controlled).

<Failure Mode (7): Sticking of Failsafe Relay onto Off State (Failsafe Relay OFF)>

This is a seventh failure mode in which failsafe relay 26, 27 cannot be turned on due to failure in failsafe relay 26, 27 or so forth. All solenoids 14 (14a through 14j) cannot be controlled (become uncontrollable states).
(a) Failsafe relay: off.
   Vbat=0 [V], Imon=0 [A], Vmon=LO.
(b) Failsafe relay: on, driving element: off.
   Vbat=0 [V], Imon=0 [A], Vmon=LO.

Since no voltage is applied from power supply 28, 29, Vbat=0 [V] and Vmon=LO, these results indicating that the corresponding part under the failure detection is nonstandard.
(c) Failsafe relay: on, driving element: on.
   Vbat≠corresponds to (equivalent to) the power supply voltage, Imon=0 [A], Vmon=LO.

Since no voltage is applied from power supply 28, 29, Vbat≠corresponds to the power supply voltage, Imon=0 [A], and Vmon=LO, these results indicating that the corresponding part (failsafe relay) under the failure detection is nonstandard.

<Failure Mode (8): Sticking of Failsafe Relay onto On State (F/S Relay ON)>

This is an eighth failsafe mode in which failsafe relay 26, 27 cannot be turned off due to the failure of failsafe relay 26, 27 or so forth. At this time, the same control as the normal mode (ordinary brake liquid pressure control) is possible. However, even if the over-current is generated due to a secondary failure, failsafe relay 26, 27 cannot be turned off and a dark current from power supply 28, 29 during a system stop is increased so that there is a possibility that a battery run-out (full discharge) is introduced.
(a) Failsafe relay :off.
   Vbat=equivalent (corresponds) to the power supply voltage, Imon=0 [A], Vmon=HI.

Since the voltage is always applied from power supply 28, 29 to solenoid 14, Vbat=equivalent (corresponds) to the power supply voltage and Vmon=HI and these results indicate that the corresponding part is nonstandard.
(b) Failsafe relay: on, driving element: off.
   Vbat=equivalent to the power supply voltage, Imon=0 [A], Vmon=HI.
(c) Failsafe relay: on, driving element: on.
   Vbat=equivalent (corresponds) to the power supply voltage, Imon=control current, Vmon=pulse.

<Failure Mode (9): Sticking of Driving Element onto the Off State (Driving Element OFF)>

This is a ninth failure mode in which an on operation of driving element 30 cannot be performed due to the failure of driving element 30. At this time, the power supply to the corresponding driving element cannot be carried out.
(a) Failsafe relay: off.
   Vbat=0 [V], Imon=0 [A], Vmon=LO.
(b) Failsafe relay: on, driving element: off.
   Vbat=equivalent (corresponds) to the power supply voltage, Imon=0 [A], Vmon=HI.
(c) Failsafe relay: on, driving element: on.
   Vbat=equivalent to the power supply voltage, Imon=0 [A], Vmon=HI.

Since driving element 30 cannot always be turned on and no current is caused to flow into solenoid 14, Imon=0 [A], and Vmon=HI, these results indicating that the corresponding part (driving element) under the failure detection is nonstandard.

<Failure Mode (10): A Sticking of Driving Element onto the On State (Driving Element ON)>

This is a tenth failure mode in which driving element 30 cannot be turned off due to the failure of the driving element (device failure) or so forth. At this time, the power supply to solenoid 14 is always carried out.
(a) Failsafe relay: off.
   Vbat=0 [V], Imon=0 [A], Vmon=LO.
(b) Failsafe relay: on, driving element: off.
   Vbat=equivalent (corresponds) to the power supply voltage, Imon=high current, Vmon=LO.
(c) Failsafe relay: on, driving element: on.
   Vbat=equivalent (corresponds) to the power supply voltage, Imon=high current, Vmon=LO.

Since driving element 30 is always in the on state, the high current is always caused to flow into solenoid 14 irrespective of the controlled variables. Imon=high current (not control current) and Vmon=LO, these results indicating that the corresponding part under the failure detection is nonstandard.

<Failure Mode (11): Sticking of Power Supply Voltage Level (Vbat Level)>

This is an eleventh failure mode in which power supply voltage detection value (Vbat) cannot indicate a normal power supply voltage due to the failure of the input circuit (9a through 9h, 8a, 8b, 17a, 17b) described above
(a) Failsafe relay: off.
   Vbat≠0 [V], Imon=0 [A], Vmon=LO.
(b) Failsafe relay: on, driving element: off
   Vbat≠corresponds (equivalent) to the power supply voltage, Imon=0 [A], Vmon=HI.
(c) Failsafe relay: on, driving element: on.
   Vbat≠corresponds (equivalent) to the power supply voltage, Imon=control current, Vmon=pulse.

<Failure Mode (12): Sticking of Current Detection Value onto High Current (Imon: High Current)>

This is a twelfth failure mode in which the current detection value (Imon) cannot detect a normal current value due to the failure in the input circuit described above. At this time, current detection value (Imon) always indicates the detection value corresponding to the high current.
(a) Failsafe relay: off.
   Vbat=0 [V], Imon=high current, Vmon=LO.
(b) Failsafe relay: on, driving element: off.
   Vbat=equivalent (corresponds) to the power supply voltage, Imon=high current, Vmon=HI
(c) Failsafe relay: on, driving element: on.
   Vbat=equivalent (corresponds) to the power supply voltage, Imon=high current, Vmon=pulse

<Failure Mode (13): Sticking of Current Detection Value onto Small-Or-Middle Current (Imon Small-Or-Middle Current)>

This is a thirteenth failure mode in which current detection value (Imon) cannot detect the normal current value due to the failure in the input circuit described above. At this time, there is a possibility that current detection value (Imon) does not always indicate the control current.
(a) Failsafe relay: off.
   Vbat=0 [V], Imon=small-or-middle current, Vmon=LO.
(b) Failsafe relay: on, driving element: off.
   Vbat=equivalent (corresponds) to the power supply voltage, Imon=small-or-middle current, Vmon=HI.
(c) Failsafe relay: on, driving element: on.
   Vbat=equivalent (corresponds) to the power supply voltage, Imon=small-or-middle current, Vmon=pulse.

<Failure Mode (14): Sticking onto Open Circuit Detection Level (Vmon Level)>

This is a fourteenth failure mode in which voltage detection value (Vmon) becomes undetectable level for the normal power supply voltage due to the failure in the input circuit described above.
(a) Failsafe relay: off.
   Vbat=0 [V], Imon=0 [A], Vmon=HI or LO.
(b) Failsafe relay: on, driving element: off.
   Vbat=equivalent (corresponds) to the power supply voltage, Imon=0 [A], Vmon=HI or LO.
(c) Failsafe relay: on, driving element: on.
   Vbat=equivalent (corresponds) to power supply voltage, Imon=control current, Vmon=HI or LO.

<Failure Mode (15): Short (Short-Circuit) of Flywheel Diode (FWD)>

This is a fifteenth failure mode in which flywheel diode (FWD) 60 is short-circuited due to the element (device) failure thereof so that the downstream side of failsafe relay 26, 27 is short-circuited (directly connected) to the downstream side of solenoid 14. At this time, during the control process, the short-circuit current (the high current) is caused to flow from a short-circuit path.
(a) Failsafe relay: off.
   Vbat=0 [V], Imon=0 [A], Vmon=LO.
(b) Failsafe relay: on, driving element: off.
   Vbat=equivalent (corresponds) to the power supply voltage, Imon=0 [A], Vmon=HI.
(c) Failsafe relay: on, driving element: on.
   Vbat=equivalent (corresponds) to the power supply Voltage, Imon=0 [A], Vmon=HI.

Since the current is not always caused to flow into solenoid 14, Imon=0 [A] and this result indicates that the corresponding part under the failure detection is nonstandard. Since open circuit detection section 70 has the same potential as the power supply voltage, Vmon=HI and this result indicates that the corresponding part under the failure detection is nonstandard. However, when driving element 30 is tuned on, often iVmon=LO, this result often indicating that Vmon indicates the normal (normality) value. In either case of detection value of Vmon, in this failure mode, corresponding solenoid 14 becomes uncontrollable.

<Failure Mode (16): Open Circuit of Flywheel Diode (FWD)>

This is a sixteenth failure mode in which flywheel diode (FWD) 60 is open-circuited (open circuit) due to the failure in the device failure of driving element. At this time, there is no path through which the flow back current to flywheel diode is caused to flow and a current controllability is deteriorated during a PWM (Pulse Width Modulation) control for solenoid 14. In addition, there is a possibility that driving element 30 is damaged due to an application of a counter electromotive force to driving element 30 by an (a counter electromotive) energy stored (charged) in solenoid 14 onto diving element 30.
(a) Failsafe relay: off.
   Vbat=0 [V], Imon=0 [A], Vmon=LO.
(b) Failsafe relay: on, driving element: off.
   Vbat=equivalent (corresponds) to the power supply voltage, Imon=0 [A], Vmon=HI
(c) Failsafe relay: on, driving element: on
   Vbat=equivalent (corresponds) to the power supply voltage, Imon≠control current, Vmon=pulse.

Since only the power supply current is caused to flow into current detection section 50, Imon≠control current and this result indicates that the corresponding part under the failure detection is nonstandard.

Next, a series of processes to specify the above-described failure modes will be described. Hereinbelow, the contents of [Failure detection timing process], [Failure detection process when the failsafe relay is in the off state], [Failure detection process when the failsafe relay is in the on state and the driving element is in the off state], [Failure detection process when the failsafe relay is in the on state and the driving element is in the on state], and [Brake control process after the failure modes are specified] will be explained.

[Failure Detection Timing Process]

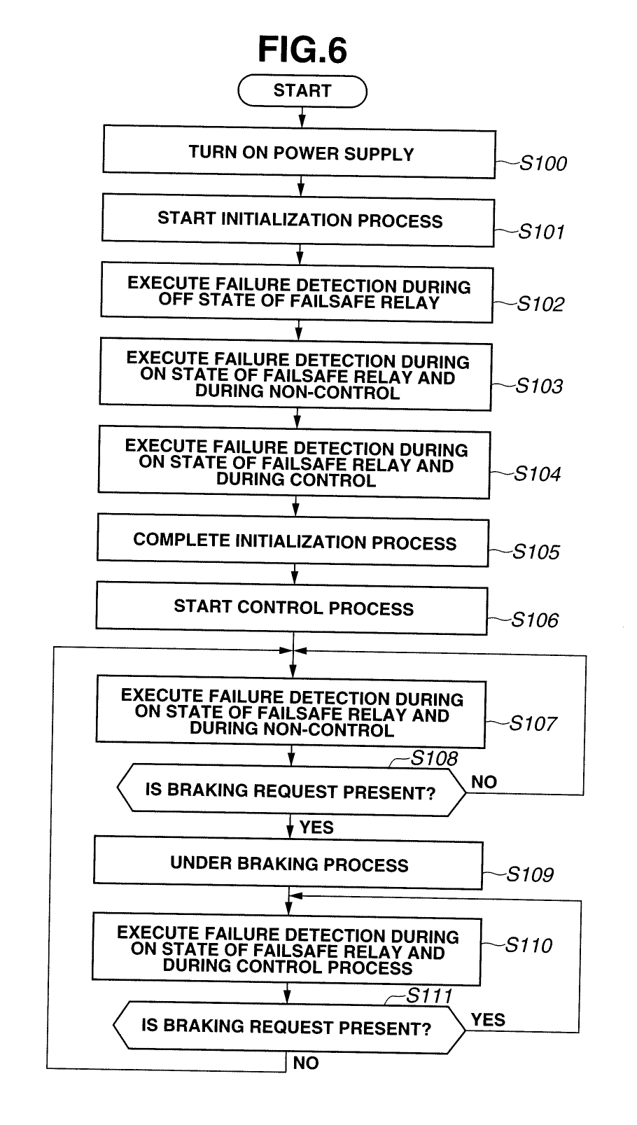

FIG. 6 shows a flowchart representing a flow of process controlling a timing at which the failure detection is carried out. Hereinafter, each step will be described below. At a step S100, the power to the control unit of brake liquid pressure control apparatus 1 is started (turn on power) and the routine goes to a step S101.

At step S101, the initialization process of the control unit of brake liquid pressure control apparatus 1 is started and the routine goes to a step S102. At step S101, first CPU 6 carries out initial settings of input circuit 9 (9a through 9h), output circuits 10 (10a through 10j), 11, 12, and RAM (Random Access Memory). At step S102, the failure detection process is executed with failsafe relay (F/S relay) 26, 27 turned off during the initialization process and the routine is transferred to a step S103.

At step S103, failsafe relay 26, 29 shown in FIG. 5A is turned on and driving element 30 shown in FIG. 5A is turned off during the initialization process to execute the failure detection and the present process is transferred to a step S104. At step S104, failsafe relay 26, 27 is turned on and driving element 30 is turned on to execute the failure detection process. Then, the routine goes to a step S105. At step S105, the initialization process is completed and the routine goes to a step S106.

At step S106, the control process is started and the routine goes to a step S107.

At step S107, failsafe relay 26, 27 is turned on and driving element 30 is turned off during the control process to execute the failure detection process and the routine is transferred to a step S108. At step S108, a presence or absence of a braking request is determined. If the presence of the braking request is determined, the routine goes to a step S109. If the braking request is not present, the routine goes to step S107. The presence of absence of the braking request is determined from various information into which first CPU 6 is inputted. At step S109, the braking process is started and the routine goes to a step S110.

At step S110, failsafe relay 26, 27 is tuned on and driving element 30 is tuned on to execute the failure detection process during the braking process and the routine goes to a step S111.

At step S111, control unit of brake liquid pressure control apparatus 1 determines whether the braking request is present. If the brake request is present (Yes) at step S111, the routine goes to step S110. If the brake request is not present (No) at step S111, the routine goes to step S107. The presence or absence of the brake request is determined from various kinds of information inputted to first CPU 6. At step S109, the braking process is started and the routine goes to step S110.

[Failure Detection Process When the Failsafe Relay is in the Off State]

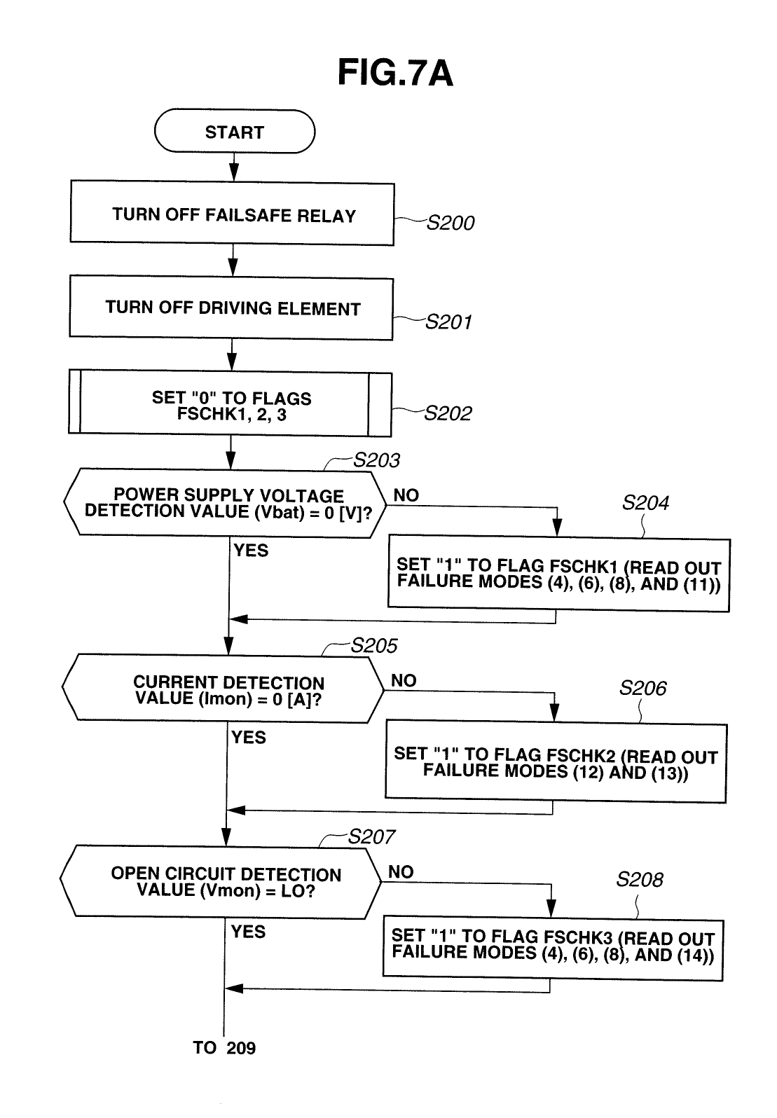

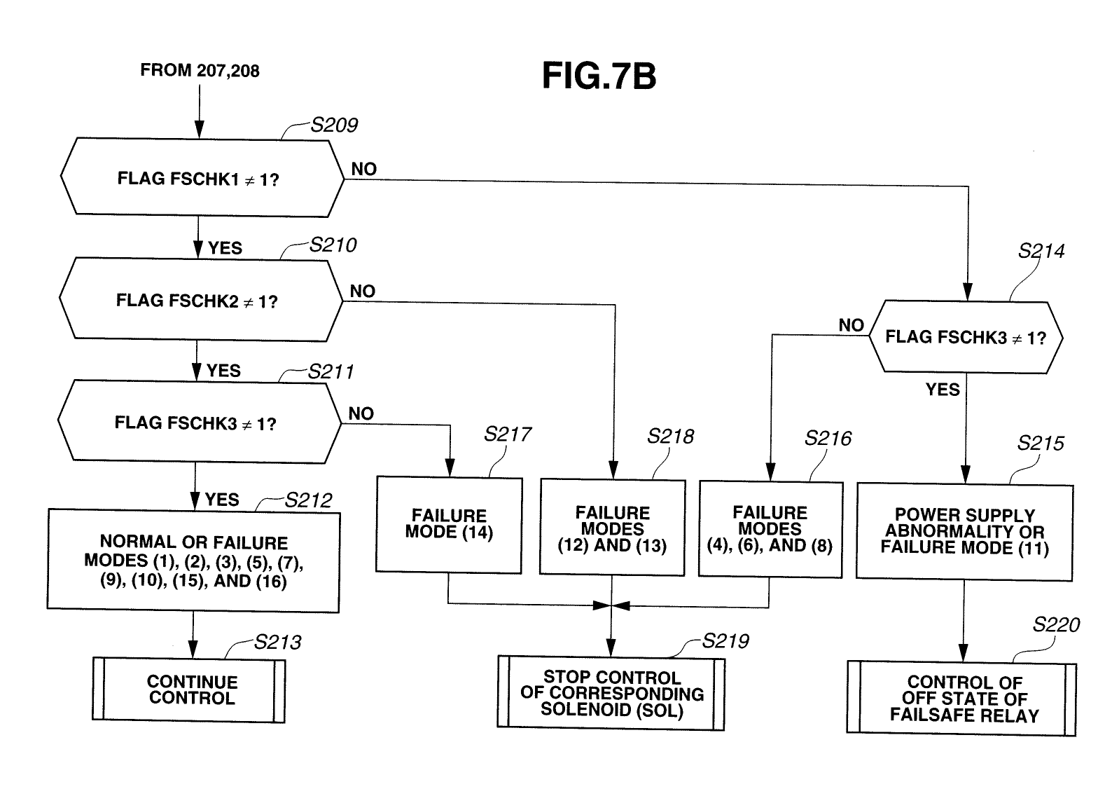

FIGS. 7A and 7B integrally show a flowchart representing a flow of the failure detection process when failsafe relay (F/S relay) 26, 27 is turned off (in the off state). Each step shown in FIGS. 7A and 7B will be described below. At a step S200, failsafe relay 26, 27 is turned off and the routine goes to a step S201. At step S201, driving element 30 is in the off state and the routine goes to a step S202.

At step S202, initializations of failure flags FSCHK1, FSCHK2, FSCHK3 (“0” is set to each failure flag) are carried out and the routine goes to step S203. At step S203, control unit of brake liquid pressure control apparatus 1 determines whether power supply voltage detection value (Vbat) indicates a normality determination value of “0 [V]”. If power supply voltage detection value (Vbat) indicates the normality determination value of 0 [V] (Yes) at step S203, the routine goes to a step S205. If not normality determination value (No) at step S203, the routine goes to a step S204.

At step S204, “1” is set to failure flag FSCHK1 and the routine goes to a step S205. At step S204, control unit of brake liquid pressure control apparatus 1 determines that the generated failure corresponds to any one of failure modes (4), (6), (8), and (11). At step S205, control unit of brake liquid pressure control apparatus 1 determines whether current detection value (Imon) indicates the normality determination value of “0 [A]”. If not normality determination value (No) at step S205, the routine goes to a step S206. If normality determination value (No) at step S205, the routine goes to a step S207.

At step S206, “1” is set to failure flag FSCHK2 and the routine goes to step S207. At step S206, the control unit of brake liquid pressure control apparatus 1 determines that the generated failure is either one of failure modes of (12) and (13). At step S207, the control unit of brake liquid pressure control apparatus 1 determines whether open circuit (open-circuit) detection value (Vmon) is the normality determination value of “LO”. If normality determination value (Yes) at step S207, the routine goes to a step S209. If not normality determination value (No) at step S207, the routine goes to a step S208.

At step S208, “1” is set to failure flag FSCHK3 and the routine goes to a step S209. At step S208, the control unit of brake liquid pressure control apparatus 1 determines that the generated failure corresponds to any one of the failure modes of (4), (6), (8), and (14). At step 209, the control unit of brake liquid pressure control apparatus 1 determines whether a step transition is made depending on a state of flag FSCHK1, namely determines whether failure flag FSCHK1 is not “1” or “1”. If failure flag FSCHK1≠1 (Yes), the routine goes to a step S210. If failure flag FSCHK=1 (No), the routine goes to a step S214.

At step S210, the control unit of brake liquid pressure control apparatus 1 determines whether the step transition is made depending on a state of failure flag FSCHK2, namely determines whether FSCHK2 is not “1” or “1”. If failure flag FSCHK2≠1 (Yes), the routine goes to a step S211. If failure flag FSCHK2=1, the routine goes to a step S218. At step S211, the control unit of brake liquid pressure control apparatus 1 determines whether the step transition is made depending on a state of flag FSCHK3, namely, determines whether flag FSCHK3 is not “1” or “1”. If failure flag FSCHK3≠1 (Yes), the routine goes to a step S212. If failure flag FSCHK3=1 (No), the routine goes to a step S217.

At step S212, failure flags FSCHK1=0, FSCHK2=0, and FSCHK3=0 and all failure flags are set to “0”s. Thus, the control unit of brake liquid pressure control apparatus 1 determines that the normal state occurs in brake liquid pressure control apparatus 1 or determines that the failure whose failure mode correspond to any one or more of failure modes (1), (2), (3), (5), (7), (9), (10), (15), and (16) occurs. Then, the routine goes to a step S213. At step S213, the control of the brake liquid pressure is continued. At step S214, the control unit of brake liquid pressure control apparatus 1 carries out the step transition depending on the state of failure flag FSCHK3. If failure flag FSCHK3≠1 (Yes) at step S214, the routine goes to a step S215. If failure flag FSCHK3=1, the routine goes to a step S216.

Since, at step S215, failure flags FSCHK1=1 and FSCHK3=0, namely, failure flag FSCHK1 indicates the abnormality value and failure flag FSCHK3 indicates the normality value, the control unit of brake liquid pressure control apparatus 1 determines that power supply 28, 29 is the abnormality value or the generated failure is in failure mode (11) and the routine goes to a step S220. At step S216, since both failure flags FSCHK1 and FSCHK3 indicate “1” (FSCHK1=1 and FSCHK3=1) and both failure flags FSCHK1 and FSCHK3 indicate the abnormality value, the control unit of brake liquid pressure control apparatus 1 determines that the generated failure is any one or more of the failure modes (4), (6), and (8) and the routine goes to a step S219.

Since, at step S217, failure flags FSCHK1=0, FSCHK2=0, and FSCHK3=1 and both of failure flags FSCHK1 and FSCHK2 indicate the normality determination value and FSCHK3 indicate the abnormality value, the control unit of brake liquid pressure control apparatus 1 determines that the generated failure is in failure mode (14) and the routine is transferred to step S219. At step S218, since failure flags FSCHK1=0 and FSCHK2=1, the failure flag FSCHK1 indicating the normality (determination) value and failure flag FSCHK2 indicating the abnormality (determination) value, the control unit of brake liquid pressure control apparatus 1 determines that the generated failure is in either of failure modes of (12) and (13) and the routine goes to step S219. At step S219, a driving control of corresponding solenoid (SOL) 14 is stopped. At step S220, the control unit of brake liquid pressure control apparatus 1 determines that the normal power supply voltage cannot be supplied to solenoid 14 and failsafe relay 26, 27 is turned off.

[Failure Detection Process When the Failsafe Relay is in the On State and the Driving Element is in the Off State]

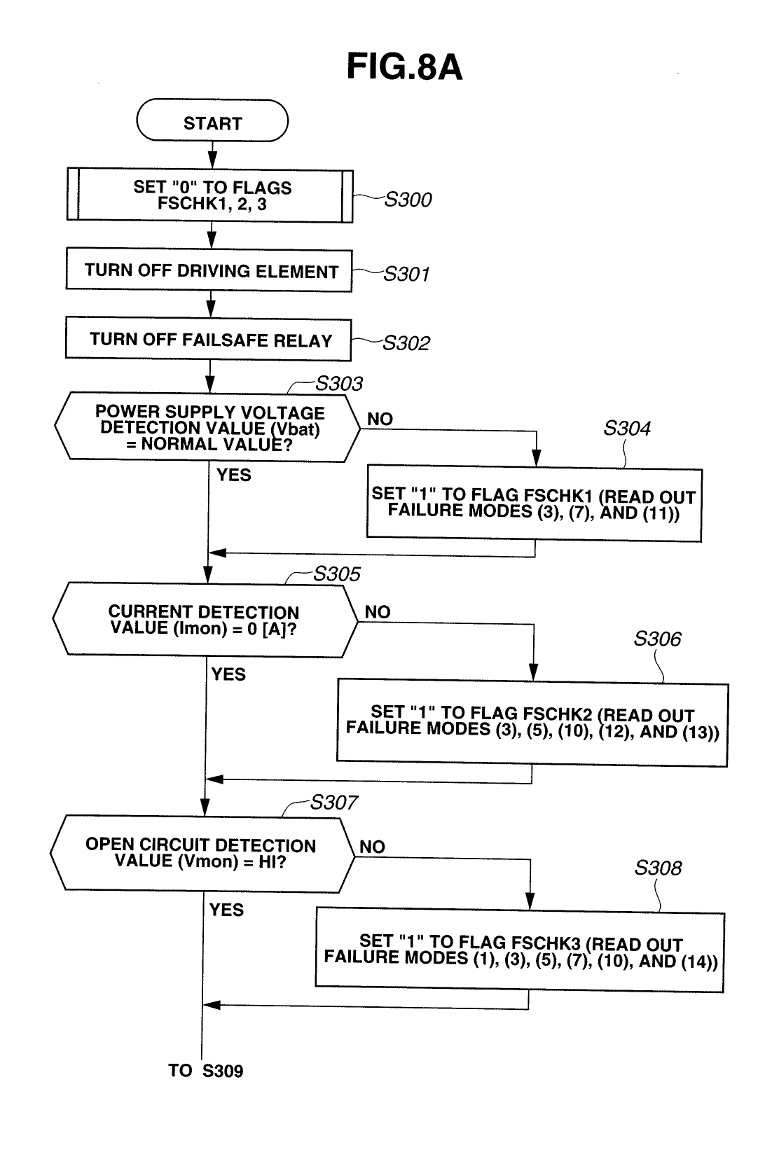

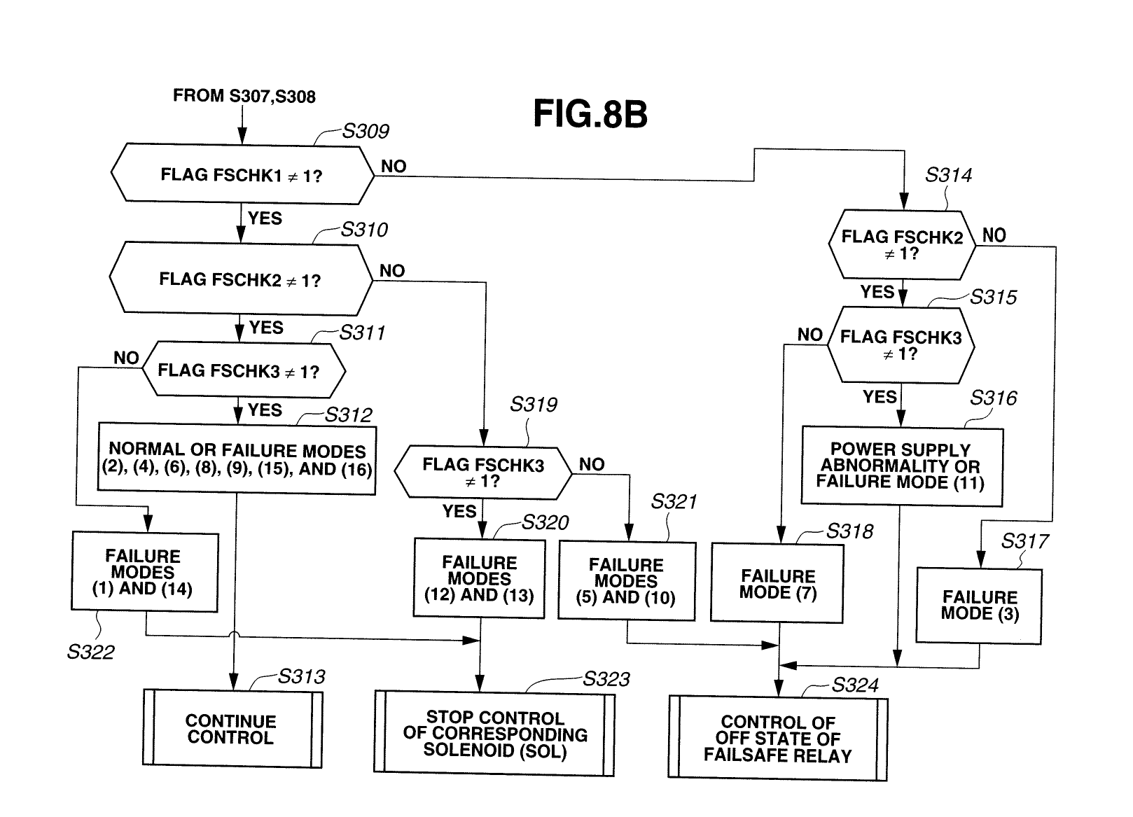

FIGS. 8A and 8B integrally show a flowchart representing a flow of the failure detection process when failsafe relay 26, 27 is turned on and driving element 30 is turned off. Hereinbelow, each step shown in FIGS. 8A and 8B will be explained. At step S300, “0” is set to each of failure flags FSCHK1, FSCHK2, and FSCHK3 and the routine goes to a step S301.

At step S301, driving element 30 is turned off and the routine goes to a step S302. At step S202, failsafe relay (F/S relay) 26, 27 is turned on and the routine goes to a step S303. At step S303, the control unit of brake liquid pressure control apparatus 1 determines whether power supply voltage detection value (Vbat) is the normality determination value “normal value.” The “normal value” described herein is a value corresponding to the power supply voltage corresponding value and is prescribed that the normal value is a supply voltage range by which the control unit can normally perform the brake operation. If normality determination value (Yes) at step S303, the routine goes to a step S305. If not the normality determination value (No) at step S303, the routine goes to a step S304.

At step S304, “1” is set to failure flag FSCHK2 and the routine goes to a step S305. At step S304, the control unit of brake liquid pressure control apparatus 1 determines that the generated failure is any one or more of the failure modes (3), (7), and (11). At step S305, the control unit of brake liquid pressure control apparatus 1 determines whether current detection value (Imon) is the normality determination value of “0 [A]”. If the normality determination value (Yes) at step S305, the routine goes to a step S307. If not normality determination value (No) at step S305, the routine goes to a step S306.

At step S306, “1” is set to failure flag FSCHK2 and the routine goes to a step S307. At this step S306, the control unit of brake liquid pressure control apparatus 1 determines that the generated failure is in any one or more of failure modes (3), (5), (10), and (13). At step S307, the control unit of brake liquid pressure control apparatus 1 determines whether open circuit detection value (Vmon) indicates the normality determination value of “HI”. If the normality determination value (Yes) at step S307, the routine goes to a step S309. If not the normality determination value (No), the routine goes to a step S308.

At step S308, “1” is set to failure flag FSCHK3 and the routine goes to a step S309. At step S308, the control unit of brake liquid pressure control apparatus 1 determines that the generated failure is in any one or more of the failure modes (1), (3), (5), (7), (10), and (14). At step S309, the control unit of brake liquid pressure control apparatus 1 determines the step transition depending on the state of failure flag FSCHK1. If FSCHK1≠1 (Yes) at step S309, the routine goes to a step S310. If failure flag FSCHK1=1 (No) at step S309, the routine goes to a step S314.

At step S310, the control unit of brake control apparatus 1 determines the step transition depending on the state of failure flag FSCHK2. If failure flag FSCHK2≠1 (Yes) at step S310, the routine goes to a step S311. If flag FSCHK2=1 (No) at step S310, the routine goes to a step S319. At step S311, the control unit of brake liquid pressure control apparatus 1 determines the step transition depending on the state of failure flag FSCHK3. If failure flag FSCHK3≠1 (Yes), the routine goes to a step S312. If failure flag FSCHK3=1 (No), the routine goes to a step S322.

At step S312, the control unit of brake liquid pressure control apparatus 1 determines that all failure flags of FSCHK1=0, FSCHK2=0, and FSCHK3=0 indicating that the apparatus under the failure detection is normal or the generated failure is in any one or more of the failure modes (2), (4), (6), (8), (9), (15), and (16) and the routine is transferred to step a S313. At step S313, the control is continued. At step S314, the control unit of brake liquid pressure control apparatus 1 determines the step transition depending upon the state of failure flag FSCHK2. If failure flag FSCH2≠1 (Yes) at step S314, the routine goes to a step S315. If failure flag FSCHK2=1 (No) at step S315, the routine goes to a step S317.

At step S315, the control unit of brake liquid pressure control apparatus 1 determines the step transition depending on the state of failure flag FSCHK3. If failure flag FSCHK3≠1 (Yes) at step S315, the routine goes to a step S316. If failure flag FSCHK3=1 (No) at step S315, the routine goes to a step S318.

At step S316, states of failure flags FSCHK1=1, FSCHK2=0, FSCHK3=0, namely, failure flag FSCHK1 indicates the abnormality, both of FSCHK2 and FSCHK3 indicate the normality. Hence, the control unit of brake liquid pressure control apparatus 1 determines that either the abnormality of power supply 28, 29 or the failure (abnormality) of failure mode (11) occurs. Then, the routine goes to a step S324.

At step S317, since states of failure flags FSCHK1=1, FSCHK2=1, both FSCHK1 and FSCHK2 indicating the abnormality, the control unit of brake liquid pressure control apparatus 1 determines that the generated failure is in failure mode (3) and the routine goes to step S324.

At step S318, failure flags FSCHK1=1, FSCHK2=0, FSCHK3=1, both failure flags FSCHK1 and FSCHK3 indicating the abnormality and failure flag FSCHK2 indicating the normality. Thus, the control unit of brake liquid pressure control apparatus 1 determines that failure mode (7) occurs (the generated failure is in the failure mode (7)) and the routine goes to step S324.

At step S319, the control unit of brake liquid pressure control apparatus 1 determines the step transition. If failure flag FSCHK3≠1 (Yes), the routine goes to a step S320. If failure flag FSCHK3=1 (No), the routine goes to a step S321. At step S320, since failure flags FSCHK1=0, FSCHK2=1, and FSCHK3=0, both failure flags FSCHK1 and FSCHK3 indicating the normality and failure flag FSCHK2 indicating abnormality, the control unit of brake liquid pressure control apparatus 1 determines that the generated failure is either one of failure modes (12) and (13) and the routine goes to step S323.

At step S321, the control unit of brake liquid pressure control apparatus 1 determines that failure flags FSCHK1=0, FSCHK2=1, and FSCHK3=1, and both of failure flags FSCHK1, FSCHK3 indicate the normality and FSCHK2 indicate the abnormality and determines that the generated failure is in the failure modes (12) and (13) and the routine is transferred to a step S324.

At step S322, since both of failure flags FSCHK1=0, FSCHK2=0, and FSCHK3=1, via., both of failure flags FSCHK1 and FSCHK2 indicate the normality and failure flag FSCHK3 indicates the abnormality, the control unit of brake liquid pressure control apparatus 1 determines that the generated failure is in either one of failure modes (1) and (14) and the routine goes to step S323. At step S323, the driving control of corresponding solenoid 14 is halted (stopped). At step S324, the control unit of brake liquid pressure control apparatus 1 determines that the normal power supply voltage cannot be supplied to solenoid 14 and failsafe relay 26, 27 is turned off.

[Failure Detection Process When Failsafe Relay is in the On State and the Driving Element is in the On State]

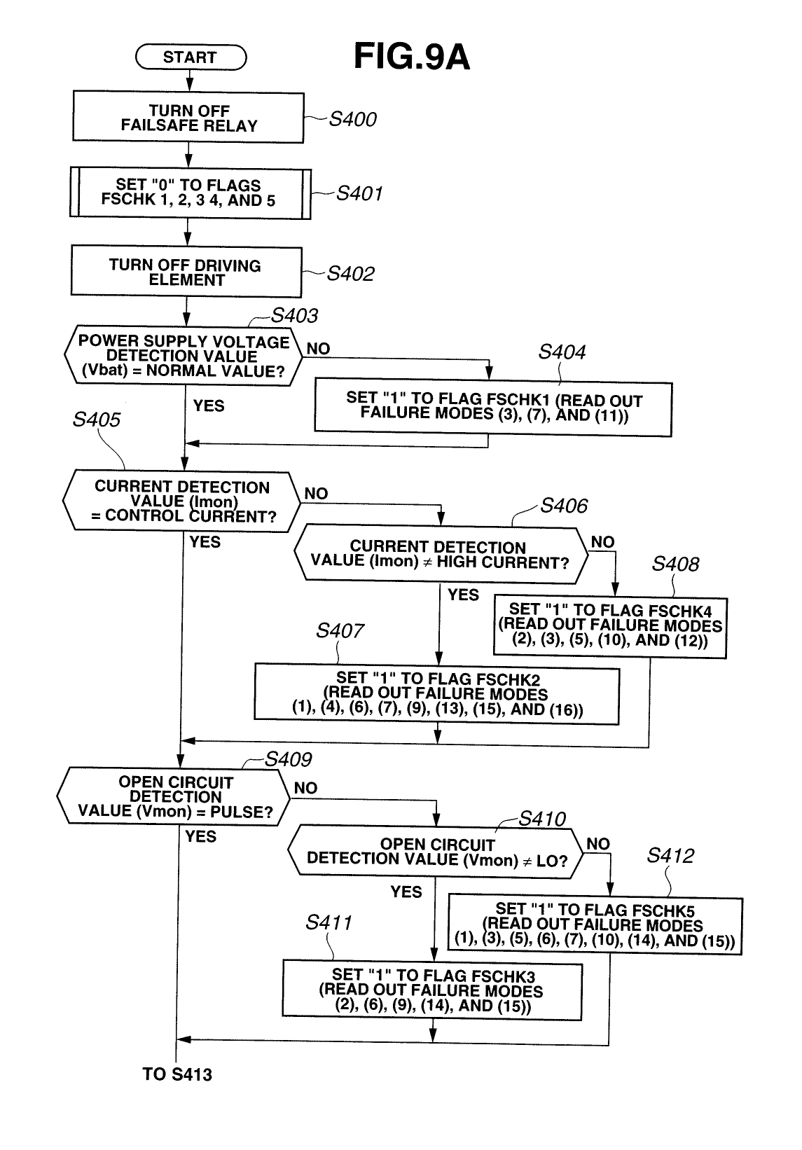

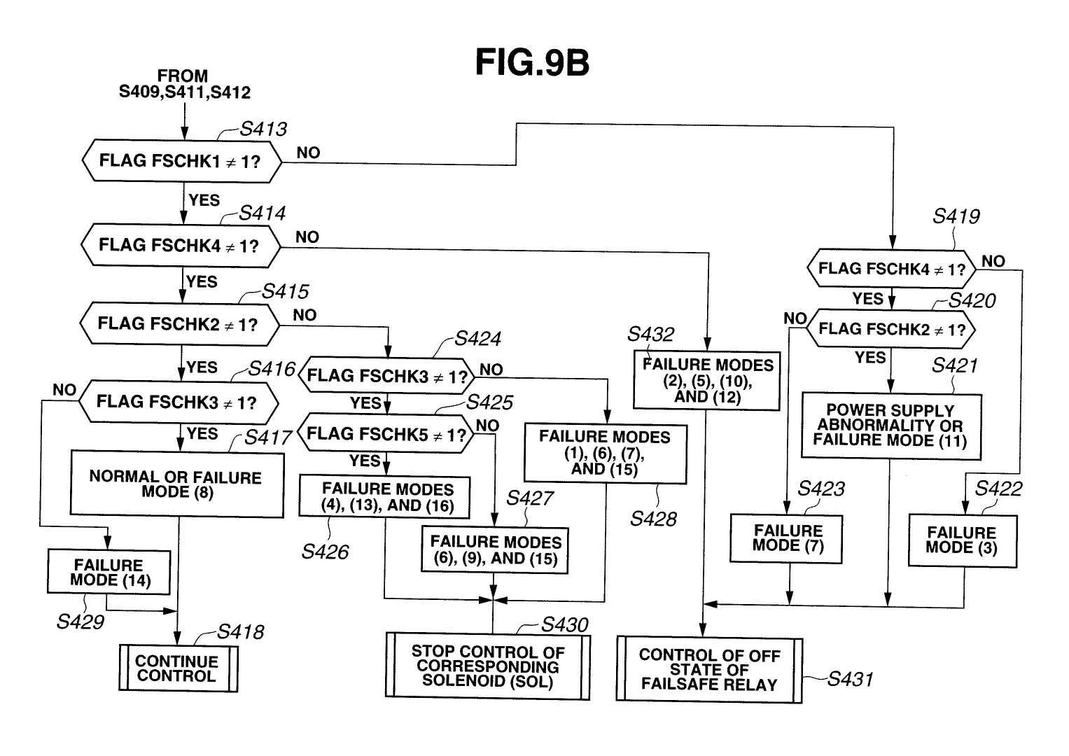

FIGS. 9A and 9B integrally show a flowchart representing the flow of failure detection process when failsafe relay 26, 27 is in the on state and the driving element is in the on state. Hereinafter, each step shown in FIGS. 9A and 9B will be described below.

At a step S400, failsafe relay (F/S relay) 26, 27 is turned on and the routine goes to a step S401.

At step S401, “0” is set to failure flags FSCHK1, FSCHK2, FSCHK3, FSCHK4, and FSCHK5 and the routine goes to a step S402. At step S402, driving element 30 is turned on and the routine goes to a step S403. At step S403, the control unit of brake liquid pressure control apparatus 1 determines whether the power supply voltage detection value (Vbat) is the normality determination value, viz., “normal value”. The normal value corresponds to the value corresponding to the power supply voltage and is prescribed by the power supply voltage range in which the control unit can normally perform braking. If normality determination value (Yes) at step S403, the routine goes to a step S405. If not normality determination value (No) at step S403, the routine goes to a step S404.

At step S404, “1” is set to failure flag FSCHK1 and the routine goes to a step S405. At step S404, the control unit of brake liquid pressure control apparatus 1 determines that the generated failure is in any one or more of failure modes of (3), (7), and (11). At step S405, the control unit of brake liquid pressure control apparatus 1 determines whether current detection value (Imon) is the normality determination value of “control current”. If normality determination value (Yes) at step S405, the routine goes to a step S409. If not normality determination value (No) at step S405, the routine goes to a step S406 (current detection value (Imon)≠high current).

At step S406, the control unit of brake liquid pressure control apparatus 1 determines whether current detection value (Imon) is not the over-current determination value “high current”. If not the high current (Yes) at step S406, the routine goes to a step S407. If the high current (No) at step S406, the routine goes to a step S408.

At step S407, “1” is set to failure flag FSCHK2 and the routine goes to step S409. At step S407, the control unit of brake liquid pressure control apparatus 1 determines that the generated failure is in any one or more of the failure modes of (1), (4), (6), (7), (9), (13), (15), and (16).

At step S408, “1” is set to failure flag FSCHK4 and the routine goes to step S409. At step S408, control unit of brake liquid pressure control apparatus 1 determines that the generated failure is in any one or more of failure modes (2), (3), (5), (10), and (12). At step S409, the control unit of brake liquid pressure control apparatus 1 determines whether open circuit detection value (Vmon) is the normality determination value of “pulse”. If the normality determination value (Yes) at step S409, the routine goes to a step S413. If open circuit detection value (Vmon) is fixed to LO or fixed to HI (No) at step S409, the routine goes to a step S410.

At step S410, the control unit of brake liquid pressure control apparatus 1 determines whether open circuit detection value (Vmon) is “LO” or not. If not “LO” (in other words, “HI”) at step S410 (Yes), the routine goes to a step S411. If not “HI” (No) at step S410, the routine goes to a step S412. At step S411, “1” is set to failure flag FSCHK3 and the routine goes to step S413. At step S411, the control unit of brake liquid pressure control apparatus 1 determines that the generated failure is in any one or more of failure modes (2), (6), (9), (14), and (15).

At step S412, “1” is set to failure flag FSCHK5 and the routine goes to a step S413. At step S412, the control unit of brake liquid pressure control apparatus 1 determines that the generated failure is in any one or more of failure modes (1), (3), (4), (6), (7), (10), (14), and (15). At step S413, the control unit of brake liquid pressure control apparatus 1 determines the step transition depending up the state of failure flag FSCHK1. If failure flag FSCHK1≠1 (Yes), the routine goes to a step S414. If failure flag FSCHK1=1 (No), the routine goes to a step S419.

At step S414, the control unit of brake liquid pressure control apparatus 1 determines the step transition depending upon the state of failure flag FSCHK4. If failure flag FSCHK4≠1 (Yes), the routine goes to a step S415. If failure flag FSCHK4=1 (No), the routine goes to a step S432. At step S415, the control unit of brake liquid pressure control apparatus 1 determines the step transition depending on the state of failure flag FSCHK2. If failure flag FSCHK2≠1 (Yes), the routine goes to a step S416. If failure flag FSCHK2=1 (No), the routine goes to a step S424.

At step S416, the control unit of brake liquid pressure control apparatus 1 determines the step transition depending upon the state of failure flag FSCHK3. If failure flag FSCHK3≠1 (Yes), the routine goes to a step S417. If failure flag FSCHK3=1 (No), the routine goes to a step S429.

At step S417, since all of failure flags FSCHK1=0, FSCHK2=0, FSCHK3=0, and FSCHK4=0, viz., all flags indicate the normality, the control unit of brake liquid pressure control apparatus 1 determines that the apparatus under the failure detection is normal or in the failure mode (8) and the routine goes to a step S418.

At step S418, the control (process) is continued. At step S419, the control unit of brake liquid pressure control apparatus 1 determines the step transition depending upon the state of failure flag FSCHK4. If failure flag FSCHK4≠1 (Yes), the routine goes to a step S420. If failure flag FSCHK4=1 (No), the routine goes to a step S422.

At step S420, the control unit of brake liquid pressure control apparatus 1 determines the step transition depending on the state of failure flag FSCHK2. If failure flag FSCHK2≠1 (Yes), the routine goes to a step S421. If failure flag FSCHK2=1 (No), the routine goes to a step S423.

At step S421, since failure flags FSCHK1=1, FSCHK2=0, FSCHK4=0, failure flag FSCHK1 indicating the abnormality and both of FSCHK2 and FSCHK4 indicating the normality, the control unit of brake liquid pressure control apparatus 1 determines that either the abnormality in power supply 28, 29 or the generated failure is in failure mode (11) and the routine goes to a step S431.

At step S422, since failure flags FSCHK1=1 and FSCHK4=1, viz., both of failure flags FSCHK1 and FSCHK4 indicate the abnormality, the control unit of brake liquid pressure control apparatus 1 determines that the generated failure is in failure mode (3) and the routine goes to step S431.

At step S423, since failure flags FSCHK1=1, FSCHK2=1, and FSCHK4=0, viz., both of failure flags FSCHK1 and FSCHK2 indicate the abnormality and FSCHK4 indicates the normality, the control unit of brake liquid pressure control apparatus 1 determines that the generated failure is in the failure mode (7) and the routine goes to step S431.

At step S424, the control unit of brake liquid pressure control apparatus 1 determines the step transition depending on the state of failure flag FSCHK3. If failure flag FSCHK3≠1 (Yes), the routine goes to a step S425. If failure flag FSCHK3=1 (No), the routine goes to a step S428.

At step S425, the control unit of brake liquid pressure control apparatus 1 determines the step transition depending upon the state of failure flag FSCHK5. If failure flag FSCHK5≠1 (Yes), the routine goes to a step S426. If failure flag FSCHK5=1 (No), the routine goes to a step S427. At step S426, the control unit of brake liquid pressure control apparatus 1 determines that the generated failure is in any one or more of failure modes (4), (13), and (16) since failure flags FSCHK1=0, FSCHK4=0, and FSCHK5=0, viz., failure flags FSCHK1, FSCHK3, FSCHK4, and FSCHK5 indicate all normality but only failure flag FSCHK2 indicates the abnormality. Then, the routine goes to a step S430.

At step S427, the control unit of brake liquid pressure control apparatus 1 determines that the generated failure is in any one or more of failure modes (6), (9), and (15) since failure flags FSCHK1=0, FSCHK2=1, FSCHK3=0, FSCHK4=0, and FSCHK5=1, viz., failure flags FSCHK1, FSCHK3, and FSCHK4 indicate the normality and both failure flags FSCHK1 and FSCHK5 indicate the abnormality. Then, the routine goes to step S430.

At step S428, the control unit of brake liquid pressure control apparatus 1 determines that the generated failure is in any one or more of failure modes (1), (6), (7), and (15) since failure flags FSCHK1=0, FSCHK2=1, FSCHK3=1, and FSCHK4=0, viz., failure flags FSCHK1 and FSCHK4 indicate the normality and both failure flags FSCHK2 and FSCHK3 indicate the abnormality. Then, the routine goes to step S430.

At step S429, since failure flags FSCHK1=0, FSCHK2=0, FSCHK3=1, and FSCHK4=0, viz., each of failure flags FSCHK1, FSCHK2, and FSCHK4 indicates the normality and FSCHK3 indicates the abnormality, the control unit of brake liquid pressure control apparatus 1 determines that the generated failure is in failure mode (14) and the routine goes to step S418. At step S430, the driving control of corresponding solenoid (SOL) 14 is stopped. At step S431, the control unit of brake liquid pressure control apparatus 1 determines that the normal power supply voltage cannot be supplied to solenoid 14 (SOL) and turns off failsafe relay (F/S relay) 26, 27.

[Brake Control Process After the Failure Modes are Specified]

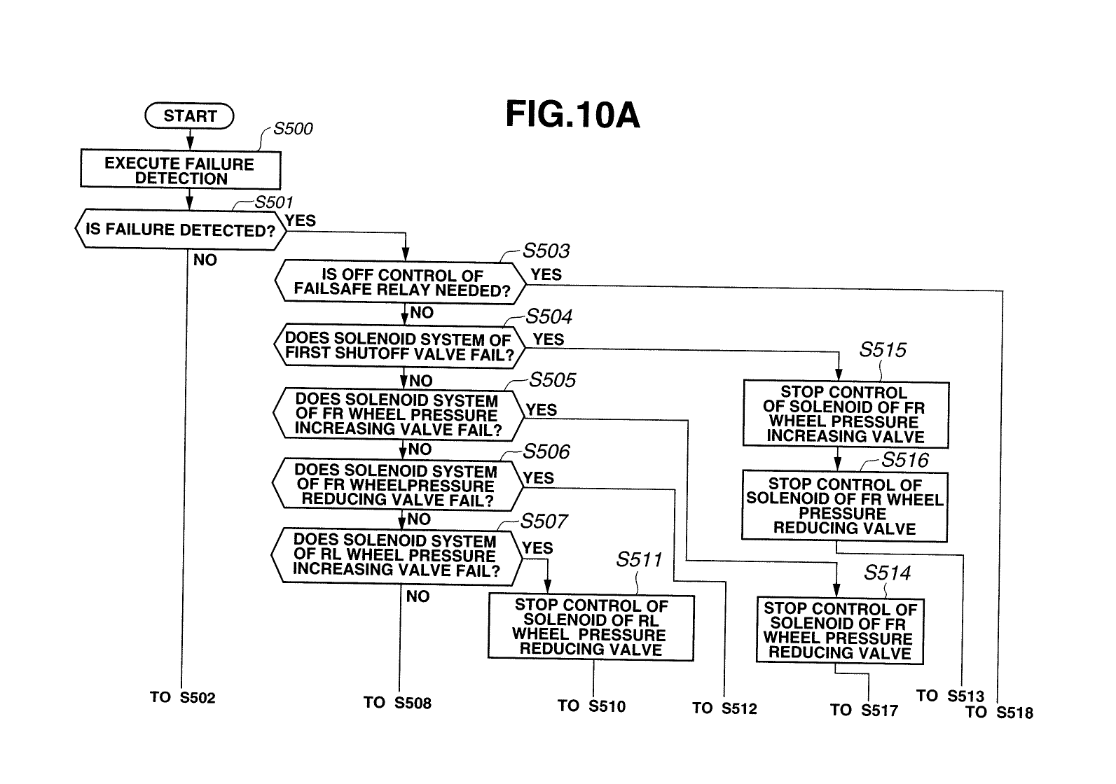

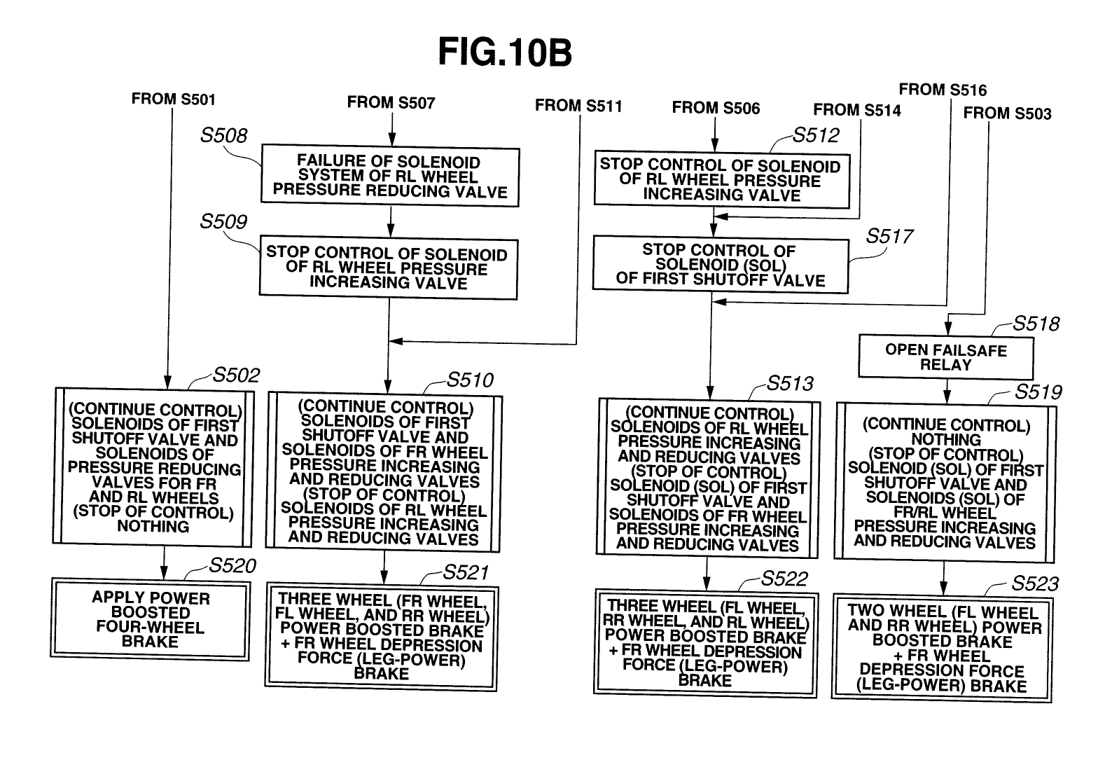

FIGS. 10A and 10B integrally show a flowchart representing a flow of the brake control process after the failure modes are specified (or determined). Each step shown in FIGS. 10A and 10B will be described below. It should, herein, be noted that only the first liquid pressure control group constituted by front right (FR) (road (wheel)) wheel pressure reducing valve solenoid 14a, front right (FR) (road (wheel)) wheel pressure increasing valve solenoid 14b, rear left (RL) (road (wheel)) wheel pressure increasing valve solenoid 14c, rear left (RL) (road (wheel)) wheel pressure reducing valve solenoid 14d, and first shutoff valve solenoid 14e will be described below and the second liquid pressure control group constituted by front left (FL) (road (wheel)) wheel pressure reducing valve solenoid 14f, front left (FL) (road (wheel)) wheel pressure increasing valve solenoid 14g, rear right (RR) (road (wheel)) wheel pressure reducing valve solenoid 14h, right rear (RR) (road (wheel)) wheel pressure reducing solenoid 14i, and second shutoff valve solenoid 14j is processed in the same way as the first liquid pressure control group (as will be described below).

At a step S500, the series of failure detection processes which have been described with reference to FIGS. 6 through 9B has been executed and the routine goes to a step S501. At step S501, the control unit of brake liquid pressure control apparatus 1 determines whether the failure has been detected. If the failure has been detected (Yes), the routine goes to a step S503. If the failure has not been detected (No), the routine goes to a step S502. It should be noted that the fact that the failure has been detected indicates a case where the control of corresponding solenoid 14 is stopped at step S219 in FIGS. 7A and 7B, at step S323 in FIGS. 8A and 8B, and at step S430 in FIGS. 9A and 9B or indicates a case where failsafe relay 26, 27 is turned off at step S220 in FIGS. 7A and 7B, at step S324 in FIGS. 8A and 8B, and at step S431 in FIGS. 9A and 9B.

At step S502, the control of front right (FR) (road (wheel)) wheel pressure reducing valve solenoid 14a, front right (FR) (road (wheel)) wheel pressure increasing valve solenoid 14b, rear left (RL) (road (wheel)) wheel pressure reducing valve solenoid 14c, rear left (RL) (road (wheel)) wheel pressure increasing valve solenoid 14d (FL/RL wheel pressure increasing and reducing valve solenoid SOL), first shutoff valve solenoid (first shutoff valve solenoid (SOL) 14e is continued and the routine goes to a step S520.

At step 5503, the control unit of brake liquid pressure control apparatus 1 determines whether the present process has reached to the process of each of step S220 in FIGS. 7A and 7B, step S324 in FIGS. 8A and 8B, and step S431 in FIGS. 9A and 9B in which failsafe relay 26, 27 is turned off (viz., whether the off control of failsafe relay 26, 27 is needed). If the present process has reached to the process in which failsafe relay 26, 27 is turned off (Yes) at step S503, the routine goes to a step S518. If the present process has not reached to the process in which failsafe relay 26, 27 is turned off (No) at step S503, the routine goes to a step 5504.

At step S504, the control unit of brake liquid pressure control apparatus 1 determines whether first shutoff valve solenoid 14e (first shutoff valve (SOL) system) has failed at step S219 in FIGS. 7A and 7B, at step S323 in FIGS. 8A and 8B, and at step S430 in FIGS. 9A and 9B. If the control of first shutoff valve solenoid 14e is stopped (Yes), the routine goes to a step S515. If the control of first shutoff valve solenoid 14e is not stopped (No), the routine goes to a step S505.

At step S505, the control unit of brake liquid pressure control apparatus 1 determines whether front right (FR) (road (wheel)) wheel pressure increasing valve solenoid 14b (FR wheel pressure reducing valve solenoid (SOL) system) has failed at step S219 in FIGS. 7A and 7B, at step S323 in FIGS. 8A and 8B, and at step S430 in FIGS. 9A and 9B. If the control of front right (FR) (road (wheel)) wheel pressure increasing valve solenoid 14b is stopped (Yes) at step S505, the routine goes to a step S514. If the control of front right (FR) (road (wheel)) wheel pressure increasing valve solenoid 14b is not stopped (No), the routine goes to a step S506.

At step S506, the control unit of brake liquid pressure control apparatus 1 determines whether front right (FR) (road (wheel)) wheel pressure reducing valve solenoid 14a (FR wheel pressure reducing valve (SOL) system) has failed at step S219 in FIGS. 7A and 7B, at step S323 in FIGS. 8A and 8B, and at step S430 in FIGS. 9A and 9B. If the control of front right (FR) (road (wheel)) wheel pressure reducing valve solenoid 14a is stopped (Yes), the routine goes to a step S512. If the control of front right (FR) (road (wheel)) wheel pressure reducing valve solenoid 14a is not stopped (No), the routine goes to a step S507.

At step S507, the control unit of brake liquid pressure control apparatus 1 determines whether rear left (RL)(road (wheel)) wheel pressure increasing valve solenoid 14d (RL wheel pressure increasing valve solenoid (SOL)) has failed at step S219 in FIGS. 7A and 7B, at step S323 in FIGS. 8A and 8B, and at step S430 in FIGS. 9A and 9B. If the control of rear left (RL) (road (wheel)) wheel pressure increasing valve solenoid 14d is stopped (Yes), the routine goes to a step S511. If the control of rear left (RL) (road (wheel)) wheel pressure increasing valve solenoid 14d is not stopped (No), the routine goes to a step S508.

At step S508, the control unit of brake liquid pressure control apparatus 1 cannot detect failed solenoid 14 by the determination of steps S504 through S507. Thus, the control unit of brake liquid pressure control apparatus 1 determines that the remaining rear left (RL) (road (wheel)) wheel pressure reducing valve solenoid 14c (RL wheel pressure increasing valve solenoid (SOL)) has failed. At step S509, the control of rear left (RL) (road (wheel)) wheel pressure increasing valve solenoid 14d is stopped and the routine goes to a step 5510.

At step S510, the control of front right (FR) (road (wheel)) wheel pressure reducing valve solenoid 14a, front right (FR) (road (wheel)) wheel pressure increasing solenoid 14b (FR wheel pressure increasing and reducing valve solenoids (SOL), and first shutoff valve solenoid 14e (first shutoff valve solenoid (SOL) is continued, the control of rear left (RL) (road (wheel)) wheel pressure reducing valve solenoid 14c and rear left (RL) (road (wheel)) wheel pressure increasing valve solenoid 14d (RL wheel pressure increasing and reducing valve solenoid SOL) is stopped, and the routine goes to a step S521.

At step S511, the control of rear left (RL) (road (wheel)) wheel pressure reducing valve solenoid 14c (RL wheel pressure reducing valve SOL) is stopped and the routine goes to a step S510.

At step S512, the control of front right (FR) (road (wheel)) wheel pressure increasing valve solenoid 14b (FR wheel pressure increasing valve solenoid (SOL)) 14b is stopped and the routine goes to a step S517.

At step S513, the control of rear left (RL) (road (wheel)) wheel pressure reducing valve solenoid 14c (RL wheel pressure reducing valve SOL) and rear left (RL) (road (wheel)) wheel pressure increasing valve solenoid 14d (RL wheel pressure increasing and reducing valve solenoids (SOL)) is continued and the control of front right (FR) (road (wheel)) wheel pressure reducing valve solenoid 14a, front right (FR) (road (wheel)) wheel pressure increasing valve solenoid 14b (FR wheel pressure increasing and reducing valve solenoids (SOL)) and first shutoff valve solenoid 14e (first shutoff valve solenoid (SOL)) is stopped, and the routine is transferred to a step S522.

At step S514, the control of front right (FR) (road (wheel)) wheel pressure reducing valve solenoid (FR wheel pressure reducing valve solenoid (SOL)) 14a is stopped and the routine goes to a step S517.

At step S515, the control of front right (FR) (road (wheel)) wheel pressure increasing valve solenoid 14b (FR wheel pressure increasing valve SOL) is stopped and the routine goes to a step S516.

At step S516, the control of front right (FR) (road (wheel)) wheel pressure reducing valve solenoid 14a (FR wheel pressure reducing valve SOL) 14a is stopped and the routine goes to step S513.

At step S517, the control of first shutoff valve solenoid 14e is stopped and the routine goes to step S513.

At step S518, failsafe relay (F/S relay) 26, 27 is opened (turned off) and the routine goes to a step S519.

At step S519, the control of front right (FR) (road (wheel)) wheel pressure reducing valve solenoid 14a, front right (FR) (road (wheel)) wheel pressure increasing valve solenoid 14b, rear left (RL) (road (wheel)) wheel pressure reducing valve solenoid 14c, rear left (RL) (road (wheel)) wheel pressure increasing valve solenoid 14d (FR/RL wheel pressure increasing and reducing valve solenoids (SOL)), and first shutoff valve solenoid 14e (first shutoff valve solenoid (SOL)) is stopped and the routine goes to a step S523.

At step S520, the control of the power boosted brake is continued for the four road wheels of the front left (FL) road wheel, the front right (FR) road wheel, the rear left (RL) road wheel, and the rear right (RR) road wheel.

At step S521, the control of the power boosted brake is performed for three road wheels of the front left (FL) road wheel, the front right (FR) road wheel, and the rear right (RR) road wheel.

At step S522, the power boosted brake control is continued for the three road wheels of the front left (FL) road wheel, the rear right left wheel (RL), and the rear right (RR) road wheel and the leg-power brake is made possible for the front right (FR) road wheel.

At step S523, the control of the power boosted brake is continued for the two wheels of the front left (FL) road wheel and rear right (RR) road wheel and the leg-power brake is made possible for the front right (FR) road wheel.

### Advantages of the Preferred Embodiment

(1) There is provided with: power supply 28, 29: solenoid 14 arranged in an electric circuit connected to power supply 28, 29: failsafe relay 26, 27 located between power supply 28, 29 and solenoid 14: driving element 30 located at the downstream side of solenoid 14: current detection section 50 disposed between solenoid 14 and failsafe relay 26, 27 to detect the current state in the electric circuit: open circuit detection section 70 disposed between solenoid 14 and driving element 30 to detect the voltage state of the electric circuit: power supply voltage detection section 80, 81 to monitor the voltage of the power supply: and CPU 6, 7 to determine an abnormality location or abnormality kind in the electric circuit on a basis of monitor results of the current state detected by current detection section, the voltage state detected by open circuit detection section 70, and the power supply voltage state detected by power supply voltage detection section 80, 81.

Therefore, it becomes possible to specify the failure required to stop the control of the apparatus urgently according to the generation of such as the overheat or so forth and the failure which is possible to continue the control although the performance of the apparatus is reduced. Thus, the countermeasure in accordance with the kind of failure can be made.

(2) There is provided with: power supply 28, 29: solenoid 14 arranged in the electric circuit connected to power supply 28, 29: failsafe relay 26, 27 located between power supply 28, 29 and solenoid 14: driving element 30 located at the downstream side of solenoid 14 to drive solenoid 14:power supply voltage detection section 80, 81 to monitor voltage of power supply 28, 29:current detection section 50 to monitor a current state in an electric circuit: and CPU 6, 7 to determine an abnormality pattern of the electric circuit on a basis of a monitor state of each detection section.

Therefore, it becomes possible to specify the failure required to stop the control of the apparatus urgently according to the generation of such as the overheat and the failure which is possible to continue the control although the performance of the apparatus is reduced. Thus, the countermeasure in accordance with the kind of failure can be made.

(3) There is provided with: power supply 28, 29: solenoid 14 arranged in the electric circuit connected to power supply 28, 29: failsafe relay 26, 27 located between power supply 28, 29 and a plurality of solenoids 14: driving elements 30, each of driving elements being located at the downstream side of a corresponding one of solenoids 14 to drive the corresponding solenoid 14: power supply voltage detection section 80, 81 to monitor voltage of power supply 28, 29: current detection section 50 to monitor a current state in the electric circuit: and CPU 6, 7 to determine an abnormality pattern of the electric circuit on a basis of the monitor state of each detection section.

Therefore, it becomes possible to specify the failure required to stop the control of the apparatus urgently according to the generation of such as the overheat and the failure which is possible to continue the control although the performance of the apparatus is reduced. Thus, the countermeasure in accordance with the kind of failure can be made.

(4) There is provided with: a wheel cylinder 43 attached onto each road wheel of the vehicle: CPU 6, 7 controlling a pressure within wheel cylinder 43 to reach to a target wheel cylinder pressure: a proportional solenoid valve 45 controlled by CPU 6, 7 during the control of the wheel cylinder pressure: power supply 28, 29 mounted on the vehicle: a control portion 2, 3 to drive the proportional solenoid valve 45 connected to power supply 28, 29: solenoid 14 arranged within control portion 2, 3: failsafe relay 26, 27 arranged within power supply 28, 29 and solenoid 14: failsafe relay 26, 27 disposed between power supply 28, 29 and solenoid 14: driving element 30 located at the downstream side of solenoid 14 to drive solenoid 14: power supply voltage detection section 80 to monitor power supply voltage 28, 29: current detection section 50 to monitor the current state in the electric circuit: open circuit detection section 70 to monitor the voltage state in the electric circuit: and CPU 6, 7 to determine an abnormality pattern of the electric circuit on a basis of the monitor states of respective detection sections.

Therefore, in the brake-by-wire brake control apparatus, it becomes possible to specify the failure required to stop the control of the apparatus urgently according to the generation of such as overheat or so forth and the failure which is possible to continue the control although the performance of the apparatus is reduced. Thus, it is not necessary to stop the brake-by-wire brake control whenever the failure occurs and the brake-by-wire control according to the kind of failure can be continued.

(5) There is provided with: power supply 28, 29: solenoid 14 arranged in the electric circuit connected to power supply 28, 29: failsafe relay 26, 27 located between power supply 28, 29 and solenoid 14: and driving element 30 located at the downstream side of solenoid 14, monitoring a current state in the electric circuit which varies in accordance with the drive of failsafe relay 26, 27 and driving element 30, between solenoid 14 and failsafe relay 26, 27, monitoring a voltage state in the electric circuit which varies in accordance with the drive of failsafe relay and driving element 30, and determining the abnormality location or kind of abnormality in the electric circuit on a basis of the monitored current state, the monitored voltage state, and the power supply voltage.

Therefore, it becomes possible to specify the failure required to stop the control of the apparatus urgently according to the generation of such as overheat and the failure which is possible to continue the control although the performance of the apparatus is reduced. Thus, the countermeasure in accordance with the kind of failure can be made.

### Other Embodiments

Hereinabove, the best mode to carry out the present invention has been described on a basis of the preferred embodiment. However, specific structures of respective inventions are not limited to the embodiment. Even if design variations and modifications are made which do not go beyond the present scope of the present invention, they are included in the present invention.

Furthermore, technical ideas which can be grasped from the embodiments described above will be described below together with descriptions of the advantages thereof.

(1) The circuit abnormality determining apparatus as claimed in claim 2, wherein, in a case where the abnormality determining section determines that at least one of a short to ground fault and an over-current flow occurs in the electric circuit, the abnormality determining section turns the power supply relay off. Therefore, in a case where the overheat is developed due to at least one of the short to ground fault of the electric circuit and the over-current flow in the electric circuit, the power supply relay is turned off to stop the power supply to the electric circuit so that a generation of the overheat can be prevented.

(2) The circuit abnormality determining apparatus as claimed in claim 2, wherein the power supply voltage monitoring section is disposed between the power supply relay and the load, the current monitoring section is disposed between the power supply voltage monitoring section and the load, and the circuit voltage monitoring section is disposed between the load and the switching element.

Therefore, the voltage at the upstream side of the load by the power supply voltage monitoring section, the voltage at the downstream side of the load by the circuit voltage monitoring section, and the current flowing through the load by the current monitoring section can be detected, respectively. Thus, at which location of the upstream side of the load, the downstream side thereof, and the load itself the abnormality is developed can be specified.

(3) The circuit abnormality determining apparatus as claimed in claim 2, wherein the power supply voltage monitoring section is disposed between the power supply relay and the load, the current monitoring section is disposed between the load and the switching element, and the circuit voltage monitoring section is disposed between the current monitoring section and the switching element.

Therefore, the voltage at the upstream side of the load by the power supply voltage monitoring section, the voltage at the downstream side of the load by the circuit voltage monitoring section, and the current flowing through the load by the current monitoring section can be detected, respectively. Thus, at which location of the upstream side of the load, the downstream side thereof, and the load itself the abnormality is developed can be specified.

(4) The circuit abnormality determining apparatus as claimed in claim 2, wherein, in place of the power supply voltage monitoring section, the circuit voltage monitoring section monitors the power supply voltage and monitors the voltage state in the electric circuit. Therefore, since it is not necessary to install the power supply voltage monitoring section, the number of parts can be suppressed.

(5) The circuit abnormality determining apparatus as claimed in claim 7, wherein the power supply relay is common to the plurality of loads. Therefore, such advantages that the suppression of the number of parts, a reduction of cost, and a reduction in a unit (apparatus) dimension can be achieved.

(6) The circuit abnormality determining apparatus as described in item (5), wherein, in a case where the abnormality determining section determines that at least one of a short to ground fault and an over-current flow occurs in the electric circuit, the abnormality determining section turns the power supply relay off. Therefore, in a case where the overheat is developed due to the short to ground (fault) of the electric circuit or the over-current flow in the electric circuit, the power supply relay is turned off to stop the power supply to the electric circuit and so that the generation of the overheat can be prevented.

(7) The circuit abnormality determining apparatus as described in item (5), wherein the power supply voltage monitoring section is disposed between the power supply relay and the plurality of loads, the current monitoring section is disposed between the power supply voltage monitoring section and each of the plurality of loads, and the circuit voltage monitoring section is disposed between each of the plurality of loads and the switching element. Therefore, the voltage at the upstream side of the load by the power supply voltage monitoring section, the voltage at the downstream side of the load by the circuit voltage monitoring section, and the current flowing through the load by the current monitoring section can be detected, respectively. Thus, at which location of the upstream side of the load, the downstream side thereof, and the load itself the abnormality is developed can be specified.

(8) The circuit abnormality determining apparatus as described in item (5), wherein the power supply voltage monitoring section is disposed between the power supply relay and the plurality of loads, the current monitoring section is disposed between each of the plurality of loads and the switching element, the circuit voltage monitoring section is disposed between the current monitoring section and the switching element. Therefore, the voltage at the upstream side of the load by the power supply voltage monitoring section, the voltage at the downstream side of the load by the circuit voltage monitoring section, and the current flowing through the load by the current monitoring section can be detected, respectively. Thus, at which location of the upstream side of the load, the downstream side thereof, and the load itself the abnormality is developed can be specified.

(9) The circuit abnormality determining apparatus as claimed in 12, Therefore, in a case where the overheat is developed due to the short to ground of the electric circuit or the over-current flow in the electric circuit, the power supply relay is turned off to stop the power supply to the electric circuit and so that the generation of the overheat can be prevented.

(10) The circuit abnormality determining apparatus applicable to the brake control apparatus as claimed in claim 12, wherein the power supply voltage monitoring section is disposed between the power supply relay and the coil, the current monitoring section is disposed between the power supply voltage monitoring and the coil, and the circuit voltage monitoring section is disposed between the coil and the switching element.

Therefore, the voltage at the upstream side of the coil by the power supply voltage monitoring section, the voltage at the downstream side of the coil by the circuit voltage monitoring section, and the current flowing through the coil by the current monitoring section can be detected, respectively. Thus, at which location of the upstream side of the coil, the downstream side thereof, and the coil itself the abnormality occurs can be specified.

(11) The circuit abnormality determining apparatus as claimed in claim 12, wherein the power supply monitoring section is disposed between the power supply relay and the coil, the current monitoring section is disposed between the coil and the switching element, and the circuit voltage monitoring section is disposed between the current monitoring section and the switching element.

Therefore, the voltage at the upstream side of the coil by the power supply voltage monitoring section, the voltage at the downstream side of the coil by the circuit voltage monitoring section, and the current flowing through the coil by the current monitoring section can be detected, respectively. Thus, at which location of the upstream side of the coil, the downstream side thereof, and the coil itself the abnormality is developed can be specified.

(12) The circuit abnormality determining method as claimed in claim 16, wherein, in a case where a determination is made that a short to ground fault or an over-current flow occurs in the electric circuit, the power supply relay is turned off. Therefore, in a case where the overheat is developed due to the short to ground of the electric circuit or the over-current flow in the electric circuit, the power supply relay is turned off to stop the power supply to the electric circuit so that the generation of the overheat can be prevented.

It should be noted that reference numeral 14 corresponds to one of 14a, 14b, 14c, 14d, 14e, 14f, 14g, 14h, 14i, and 14j, reference numeral 30 corresponds to one of 30a, 30b, 30c, 30d, 30e, 30f, 30g, 30h, 30i, and 30h, reference numeral 50 corresponds to one of 50a, 50b, 50c, 50d, 50e, 50f, 50g, 50h, 50i, and 50j, reference numeral 60 corresponds to one of 60a, 60b, 60c, 60d, 60e, 60f, 60g, 60h, 60i, and 60j, reference numeral 70 corresponds to one of 70a, 70b, 70c, 70d, 70f, 70g, 70h, 70i, and 70j, and the term of “equivalent to” described in the specification and the drawings is used to mean as “approximately equal to” or “corresponds to”.

This application is based on a prior Japanese Patent Application No. 2007-073851. The entire contents of the Japanese Patent Application No. 2007-073851 with a filing date of Mar. 22, 2007 are hereby incorporated by reference. Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

1. A circuit abnormality determining apparatus, comprising:
a power supply:
a load disposed in an electric circuit connected to the power supply;
a first switching element located between the power supply and the load;
a second switching element located at a downstream side of the load;
current detecting means for detecting a current state in the electric circuit, the current detecting means being disposed between the load and the first switching element;
voltage detecting means for detecting a voltage state of the electric circuit, the voltage detecting means being disposed between the load and the second switching element;
power supply voltage monitoring means for monitoring a voltage of the power supply; and
abnormality determining means for determining at least one of an abnormality location of the electric circuit and a kind of abnormality of the electric circuit on a basis of monitoring results of the current state detected by the current detecting means, of the voltage state detected by the voltage detecting means, and of the power supply voltage monitoring means.

2. A circuit abnormality determining apparatus, comprising:
a power supply;
a load disposed in an electric circuit connected to the power supply;
a power supply relay located between the power supply and the load;
a switching element located at a downstream side of the load and configured to drive the load;
a power supply voltage monitoring section configured to monitor a voltage of the power supply;
a current monitoring section configured to monitor a current state in the electric circuit;
a circuit voltage monitoring section configured to monitor a voltage state in the electric circuit; and
an abnormality determining section configured to determine an abnormality pattern of the electric circuit on a basis of a monitoring state of each of the power supply voltage monitoring section, the current monitoring section, and the circuit voltage monitoring section.

3. The circuit abnormality determining apparatus as claimed in claim 2, wherein, in a case where the abnormality determining section determines that at least one of a short to ground fault and an over-current flow occurs in the electric circuit, the abnormality determining section turns the power supply relay off.

4. The circuit abnormality determining apparatus as claimed in claim 2, wherein the power supply voltage monitoring section is disposed between the power supply relay and the load, the current monitoring section is disposed between the power supply voltage monitoring section and the load, and the circuit voltage monitoring section is disposed between the load and the switching element.

5. The circuit abnormality determining apparatus as claimed in claim 2, wherein the power supply voltage monitoring section is disposed between the power supply relay and the load, the current monitoring section is disposed between the load and the switching element, and the circuit voltage monitoring section is disposed between the current monitoring section and the switching element.

6. The circuit abnormality determining apparatus as claimed in claim 2, wherein, in place of the power supply voltage monitoring section, the circuit voltage monitoring section monitors the power supply voltage and monitors the voltage state in the electric circuit.

7. A circuit abnormality determining apparatus, comprising:
a power supply;
a plurality of loads disposed in an electric circuit connected to the power supply;
a power supply relay located between the power supply and the plurality of loads;
a switching element located at a downstream side of each of the plurality of loads and configured to drive a corresponding one of the plurality of loads;
a power supply voltage monitoring section configured to monitor a voltage of the power supply;
a current monitoring section configured to monitor a current state in the electric circuit;
a circuit voltage monitoring section configured to monitor a voltage state in the electric circuit; and
an abnormality determining section configured to determine an abnormality pattern of the electric circuit on a basis of a monitoring state of each of the power supply voltage monitoring section, the current monitoring section, and the circuit voltage monitoring section.

8. The circuit abnormality determining apparatus as claimed in claim 7, wherein the power supply relay is common to the plurality of loads.

9. The circuit abnormality determining apparatus as claimed in claim 8, wherein, in a case where the abnormality determining section determines that at least one of a short to ground fault and an over-current flow occurs in the electric circuit, the abnormality determining section turns the power supply relay off.

10. The circuit abnormality determining apparatus as claimed in claim 8, wherein the power supply voltage monitoring section is disposed between the power supply relay and the plurality of loads, the current monitoring section is disposed between the power supply voltage monitoring section and each of the plurality of loads, and the circuit voltage monitoring section is disposed between each of the plurality of loads and the switching element.

11. The circuit abnormality determining apparatus as claimed in claim 8, wherein the power supply voltage monitoring section is disposed between the power supply relay and the plurality of loads, the current monitoring section is disposed between each of the plurality of loads and the switching element, the circuit voltage monitoring section is disposed between the current monitoring section and the switching element.

12. A circuit abnormality determining apparatus applicable to a brake control apparatus, comprising:
a wheel cylinder attached onto each of road wheels of a vehicle;
a control unit configured to control a pressure in the wheel cylinder to reach to a target wheel cylinder pressure;
a proportional solenoid valve controlled by the control unit during a control of the pressure in the wheel cylinder;
a power supply mounted in the vehicle;
a solenoid valve drive circuit connected to the power supply and configured to drive the proportional solenoid valve;
a coil disposed in the solenoid valve drive circuit;
a power supply relay located between the power supply and the coil;
a switching element located at a downstream side of the coil and configured to drive the coil;
a power supply voltage monitoring section configured to monitor a voltage of the power supply;
a current monitoring section configured to monitor a current in the solenoid drive circuit;
a circuit voltage monitoring section configured to monitor a voltage state in the solenoid drive circuit; and
an abnormality determining section configured to determine an abnormality pattern of the solenoid valve drive circuit on a basis of a monitoring state of each of the power supply voltage monitoring section, the current monitoring section, and the circuit voltage monitoring section.

13. The circuit abnormality determining apparatus applicable to the brake control apparatus as claimed in claim 12, wherein, in a case where the abnormality determining section determines that at least one of a short to ground fault or an over-current flow occurs in the solenoid valve drive circuit, the abnormality determining section turns the power supply relay off.

14. The circuit abnormality determining apparatus applicable to the brake control apparatus as claimed in claim 12, wherein the power supply voltage monitoring section is disposed between the power supply relay and the coil, the current monitoring section is disposed between the power supply voltage monitoring and the coil, and the circuit voltage monitoring section is disposed between the coil and the switching element.

15. The circuit abnormality determining apparatus applicable to the brake control apparatus as claimed in claim 12, wherein the power supply monitoring section is disposed between the power supply relay and the coil, the current monitoring section is disposed between the coil and the switching element, and the circuit voltage monitoring section is disposed between the current monitoring section and the switching element.

16. A circuit abnormality determining method, comprising:
providing a power supply;
providing a load disposed in an electric circuit connected to the power supply;
providing a first switching element located between the power supply and the load;
providing a second switching element located at a downstream side of the load; and
determining at least one of a location of an abnormality in the electric circuit and a kind of the abnormality of the electric circuit on a basis of a current state in the electric circuit which varies in accordance with a drive of at least one of the first switching element and the second switching element, at a position in the electric circuit between the load and the first switching element, a voltage state of the electric circuit which varies in accordance with a drive of at least one of the first switching element and the second switching element, at another position in the electric circuit between the load and the second switching element, and the voltage state of the power supply.

17. The circuit abnormality determining method as claimed in claim 16, wherein, in a case where a determination is made that a short to ground fault or an over-current flow occurs in the electric circuit, a power supply relay is turned off.
